(19) United States
(12) Patent Application Publication
(10) Pub. No.: US 2026/0312109 A1
(43) Pub. Date: Oct. 8, 2026

(54) A MEMBRANE ELECTRODE ASSEMBLY AND A METHOD FOR THE MANUFACTURE THEREOF

(71) Applicants: W. L. Gore & Associates, Inc., Newark, DE (US); W. L. GORE & ASSOCIATES GMBH, PUTZBRUNN (DE); W. L. GORE & ASSOCIATES G.K., Tokyo (JP)

(72) Inventors: Matthew J. CRUM, Newark, DE (US); Masaki TANI, Tokyo (JP); Masashi MARUYAMA, Tokyo (JP); Thomas BERTA, Newark, DE (US); Amr Mahmoud Hamdy Kobaisy ALI, Putzbrunn (DE); Mark D. EDMUNDSON, Newark, DE (US)

(21) Appl. No.: 19/483,746

(22) PCT Filed: May 15, 2024
(86) PCT No.: PCT/EP2024/063448

§ 371 Date: Nov. 12, 2025

Related U.S. Application Data
(60) Provisional application No. 63/502,147, filed on May 15, 2023.

(51) Int. Cl. H01M 8/106; H01M 4/88; H01M 8/10; H01M 8/1004; H01M 8/1067; H01M 8/1086

(52) U.S. Cl. CPC H01M 8/106; H01M 4/881; H01M 8/1004; H01M 8/1067; H01M 8/109; H01M 2008/1095

(57) ABSTRACT

There is provided a membrane electrode assembly (MEA) for an electrochemical devices, such as for fuel cells and electrolyzers, particularly for polymer electrolyte membrane (PEM) fuel cells, said membrane electrode assembly comprising a composite electrolyte membrane comprising a reinforced electrolyte layer comprising at least one porous support, the porous support being at least partially imbibed with a first ion exchange material; and a first electrode comprising a reinforced electrode layer comprising a porous support, the porous support being at least partially imbibed with a first catalyst and a second ion exchange material, wherein the composite electrolyte membrane is in contact with the first electrode. Also provided is a composite electrolyte membrane, which can be used in the manufacture of the membrane electrode assembly and a fuel cell and electrolyzer comprising such a membrane electrode assembly. A method for the manufacture of the membrane electrode assembly, and a membrane electrode assembly obtainable by such a method are also disclosed.

### FIELD OF THE INVENTION

This disclosure relates to a membrane electrode assembly (MEA) for electrochemical devices, such as for a fuel cell and an electrolyzer, particularly for polymer electrolyte membrane (PEM) fuel cells. Also provided is a fuel cell and electrolyzer comprising such a membrane electrode assembly. A method for the manufacture of the membrane electrode assembly, and a membrane electrode assembly obtainable by such a method are also disclosed.

### BACKGROUND

A Membrane Electrode Assembly (MEA) is a core component of an electrochemical device and is the location where the electrochemical reactions take place. In a fuel cell, these electrochemical reactions generate power. In an electrolyzer, these electrochemical reactions generate hydrogen and oxygen. A typical MEA comprises an electrolyte membrane, such as a polymer electrolyte membrane (PEM), and two electrode layers comprising catalyst (i.e., the anode and the cathode), which are attached to opposite sides of the electrolyte membrane in a multi-layer assembly. Additionally, the MEA may also include gas diffusion layers (GDLs), which are attached to the outer surfaces of each electrode layers, opposite to those surfaces in contact with the electrolyte membrane. The GDLs are typically comprised of carbon paper. If two GDLs are present with one attached to each electrode layer, then the final MEA is considered a multi-layer e.g. five-layer, assembly including a first layer of GDL, an anode layer (i.e. electrode layer), an electrolyte membrane layer, a cathode layer (i.e. electrode layer) and another, second, layer of GDL.

Typically, the electrolyte membrane and GDLs have sufficient mechanical integrity to be self-supporting, but the electrode layers do not. Therefore, each electrode layer is typically formed on a substrate which may be the electrolyte membrane, a GDL, or a releasable support layer. The layers of the MEA are then bonded together with heat and/or pressure as needed to form a multi-layer assembly.

The electrolyte membrane, such as a PEM, separates two reactants, such as reactant gas streams. In a fuel cell, on the anode side of the MEA, a fuel, e.g., hydrogen gas, is oxidized, e.g., to separate the electrons and protons. The cell is designed so that the electrons travel through an external circuit while the ions such as protons migrate through the electrolyte membrane. On the cathode side the electrons and ions such as protons react with an oxidizing agent (i.e., oxygen or air) to produce water and heat. In this manner, an electrochemical potential is maintained and current can be drawn from the fuel cell to perform useful work.

An electrolyzer hydrolyzes water to generate hydrogen and oxygen. The reactions that take place in an electrolyzer are very similar to the reaction in fuel cells, except that the reactions that occur in the anode and cathode are reversed. In a fuel cell the anode is where hydrogen gas is consumed and in an electrolyzer the hydrogen gas is produced at the cathode. A PEM electrolyzer uses the same type of electrolyte membrane as a PEM fuel cell.

There are various established techniques for forming the electrodes on an electrolyte membrane and/or bonding the electrodes to other layers of the MEA. However, each technique has its own problems. In one known method, the electrodes are coated onto a releasable support layer and then laminated to an electrolyte membrane, such as a PEM. However, this method is inefficient and costly, requiring the initial manufacture of an electrode layer on a releasable support layer and then the lamination of the electrode layer on the electrolyte membrane and the removal of the releasable support layer whilst the electrode layer must be retained on the electrolyte membrane layer.

More recently, this addition of an electrode layer to an electrolyte membrane layer has been streamlined by coating a liquid electrode composition directly onto the electrolyte membrane, such as a PEM, and drying the composition to form the electrode layer. However, coating the electrode composition directly on the electrolyte membrane can produce an electrode layer with undesirable properties. In particular, the coated liquid electrode layer compositions comprise catalyst, ion exchange material and liquid carrier, such as water and/or alcohol. Upon drying to provide an electrode layer, the liquid carrier evaporates from the surface of the coated liquid electrode layer. The evaporation of the liquid carrier can increase the capillary stress of the liquid, which can lead to cracking in the dried electrode layer. In addition, direct contact of the electrolyte membrane with the liquid carrier of the coated liquid electrode layer can induce the swelling of the electrolyte membrane, which may also produce cracking of the dried electrode layer as the electrolyte membrane expands from contact with the liquid carrier and then contracts upon removal of the liquid carrier by evaporation. This cracking of the dry electrode layer can lead to a reduction in the performance of the electrochemical device containing such an MEA, for instance a fuel cell. Such a performance reduction may include voltage drop (also known as over voltage).

It will be apparent that an MEA manufactured by the lamination of a dried electrode coated onto a releasable support to an electrolyte membrane does not suffer from such problems because the coated liquid electrode layer composition comprising the liquid carrier is coated onto a releasable support and dried to form the dried electrode layer before the dried electrode layer is laminated to an electrolyte membrane. This means that the liquid carrier is not present in any substantial amount when the dried electrode layer is contacted with the electrolyte membrane.

However, whether the electrode layer is contacted with the electrolyte membrane by laminating or by coating a liquid electrode layer composition, the electrode layer can separate from the electrolyte membrane, particularly under wet conditions and/or cycling between wet and dry conditions. Consequently, a need exists for improved MEA constructions, and particularly electrolyte membranes and MEAs with an improved interface between each other.

Typically, the electrolyte membrane comprises at least one reinforcement, such as at least one porous support, such as a porous polymer sheet. Furthermore, a homogeneous porous polymer sheet is not generally compatible with both coating liquid electrolyte compositions and coating liquid electrode compositions. Consequently, the use of homogeneous porous polymer sheets conventionally used as reinforcement for polymer electrolyte membranes have a relatively tight pore structure which poorly imbibe coating liquid electrode compositions.

Therefore, the provision of MEAs by direct coating of the electrode composition on the electrolyte membrane may be limited by reduced performance. Accordingly, a need exists for improved electrolyte membrane and MEA constructions, and particularly electrolyte membranes on which the electrode layer composition may be directly coated to provide MEAs with improved performance and MEAs which can be manufactured by direct coating of the electrode layer composition and which provides an MEA with improved performance.

### SUMMARY

This disclosure addresses the problems mentioned above. In a first aspect, there is provided a membrane electrode assembly for an electrochemical device, said membrane electrode assembly comprising:
a composite electrolyte membrane comprising a reinforced electrolyte layer comprising at least one first porous support including a first porous support, the first porous support being at least partially imbibed with a first ion exchange material; and
a first electrode comprising a reinforced electrode layer comprising a second porous support, the second porous support being at least partially imbibed with a second ion exchange material and a first catalyst;
wherein the composite electrolyte membrane is in contact with the first electrode.

A first electrode comprising a second porous support provides improved structural integrity to the first catalyst and second ion exchange material which is at least partially imbibed into it. Providing a second porous support at least partially imbibed with the first catalyst and second ion exchange material can mitigate the cracking of the first electrode during manufacture, and particularly during the drying of a liquid electrode composition comprising the first catalyst, the second ion exchange material and a liquid carrier which is used to impregnate the first catalyst and the ion exchange material into the second porous support.

Furthermore, the second porous support of the first electrode may be provided with a low mass per area weight to avoid increased proton resistance of the reinforced electrode layer. The thickness of the second porous support of the first electrode can be selected to accommodate the thickness of the first electrode e.g. 15 μm.

The first porous support of the composite electrolyte membrane is imbibed with the first ion exchange material to provide a reinforced electrolyte layer. Thus, the reinforced electrolyte layer comprises the first porous support at least partially imbibed with the first ion exchange material. The reinforced electrolyte layer may be substantially free from the first catalyst.

In another embodiment, the first porous support of the reinforced electrolyte layer and the second porous support of the reinforced electrode layer are the same porous support. The porous support may be made of the same material with the same properties i.e. a homogeneous porous support or the porous support may be made of the same material with different properties in different regions i.e. a non-homogeneous porous support. For instance, the porous support may be homogeneous with a uniform bubble point or may be non-homogeneous with regions having different bubble points.

In an alternative embodiment, the first porous support of the reinforced electrolyte layer and the second porous support of the reinforced electrode layer are different porous supports. These different porous supports may be made of the same material with the same or different properties or may be made of different materials with the same or different properties.

In a further embodiment, the first porous support (of the reinforced electrolyte layer) has a first bubble point, and the second porous support (of the reinforced electrode layer) has a second bubble point. The first bubble point of the first porous support and the second bubble point of the second porous support may be the same. Alternatively, the second bubble point of the second porous support is less than the first bubble point of the first porous support.

The at least one first porous support may comprise a plurality of first porous supports. Each of the plurality of first porous supports may be at least partially imbibed with the first ion exchange material. Distributing the first support between two or more first porous supports may increase the resistance to piercing of the composite electrolyte membrane, such as by piercing from a fibrous diffusion layer or electrode component during manufacture of a membrane electrode assembly or electrochemical device. Adjacent first porous supports may be in contact, or they may be separated, for instance by a layer of first ion exchange material, such as an intermediate layer of first ion exchange material.

In a second aspect, there is provided a membrane electrode assembly for an electrochemical device, said membrane electrode assembly comprising:
a composite electrolyte membrane comprising a reinforced electrolyte layer comprising a first porous support having a first bubble point, the first porous support being at least partially imbibed with a first ion exchange material; and
a first electrode comprising a reinforced electrode layer comprising a second porous support having a second bubble point, the second porous support being at least partially imbibed with a first catalyst and a second ion exchange material;
wherein the composite electrolyte membrane is in contact with the first electrode and the second bubble point of the second porous support is less than the first bubble point of the first porous support.

Such an MEA has different porous supports for the electrode and composite electrolyte membrane or has a unitary porous support with different portions or regions, with properties which improve the imbibing of the coating liquid compositions. In particular, the second bubble point of the second porous support or second portion is less than the first bubble point of the first porous support or first portion. The relatively lower second bubble point of the second porous support or second portion provides an open structure allowing improved penetration of first catalyst and second ion exchange material into the pore structure. The relatively higher first bubble point of the first porous support or first portion provides a less open, tighter structure for the imbibing of first ion exchange material into the pore structure. Such a membrane electrode assembly is provided with improved properties. For instance, the first electrode can exhibit less cracking during manufacture compared to an electrode without a porous support. The first electrode may also be manufactured within wider coating parameters, such as the rate at which the liquid first electrode composition can be applied. Such MEAs also exhibit improved interface between the composite electrolyte membrane and first electrode, reducing delamination during operation of the MEA.

The first porous support may comprise a plurality of first porous supports. Each of the plurality of first porous supports may be at least partially imbibed with the first ion exchange material. Distributing the first support between two or more first porous supports may increase the resistance to piercing of the composite electrolyte membrane, such as by piercing from a fibrous diffusion layer or electrode component during manufacture of a membrane electrode assembly or electrochemical device. Adjacent first porous supports may be in contact, or they may be separated, for instance by a layer of first ion exchange material, for instance by a layer of first ion exchange material, such as an intermediate layer of first ion exchange material.

In one embodiment of the first or second aspects, the first porous support may be in contact with the second porous support.

In an embodiment of the first or second aspects, the first porous support and the second porous support are unitary. As used herein the term “unitary” support is intended to mean that the porous support, in this case the first and second porous support, forms a single entity, for instance an entity which cannot be separated into a first porous portion and a second porous portion without the destruction of the porous support. Thus, the first porous support may comprise a first porous portion or first region of the unitary support and the second porous support may comprise a second porous portion or second region of the unitary support. The second porous portion or second region of the unitary porous support has a second bubble point which is less than the first bubble point of the first porous portion or first region.

In another embodiment of the first or second aspects, the membrane electrode assembly further comprises a second electrode comprising a second catalyst and a third ion exchange material, wherein the second electrode is in contact with the composite electrolyte membrane and the composite electrolyte membrane is located between the first and second electrodes.

In another embodiment of the first or second aspects, the first porous support and the second porous support may be separated i.e. the first and second porous supports are not in contact. For instance, a layer, such as a first layer, of first ion exchange material may be present between the first porous support and second porous support. The first layer of first ion exchange material may not contain a porous support, such that it is a first unreinforced layer of first ion exchange material or a first unreinforced electrolyte layer. The first layer of first ion exchange material may be located between the reinforced electrolyte layer and the first electrode. The first layer of unreinforced first ion exchange material may be free of first catalyst and optionally second ion exchange material. The composite electrolyte membrane may comprise such a first unreinforced electrolyte layer as part of the composite electrolyte.

The layer of first ion exchange material, such as a first layer of first ion exchange material may further comprise a recombination catalyst. A recombination catalyst catalytically reacts any excess permeated hydrogen crossing through the composite electrolyte membrane between electrodes with oxygen in a controlled manner to form water, and eventually electrochemically oxidizes the permeated hydrogen to protons. It is desirable to restrict hydrogen crossover to a maximum of 2% H₂ in O₂ (typically the safety limit is considered to be 50% of the lower explosion limit, which is 4% H₂ in O₂). When the electrochemical device comprising the MEA is an electrolyzer, hydrogen may permeate from the cathode towards the anode. Disposing the recombination catalyst closer to the anode than to the cathode, or near or adjacent to the anode, can eliminate the permeating hydrogen before it reaches the anode by reaction with oxygen from the anode in a controlled manner.

The recombination catalyst may be configured to be disposed adjacent to the first electrode forming the anode of an electrolyzer MEA. Within the context of this disclosure, adjacent to the anode may mean that the recombination catalyst is closer to the anode than to the cathode in a MEA. A portion of the electrolyzer composite membrane which is disposed adjacent to the anode may be disposed in contact with the anode. The recombination catalyst may be disposed in contact with an anode. Within the context of this disclosure, “in contact with” comprises “in direct contact with” and “in indirect contact with”. Therefore, in some embodiments, the recombination catalyst may be disposed in direct contact with the anode (without any intervening layers or elements). In other embodiments of the first and second aspects, the recombination catalyst may be disposed in indirect contact with the anode.

Thus, the layer of first ion exchange material further comprising a recombination catalyst may be disposed near the anode when the first electrode is the anode. Therefore, the MEAs disclosed herein present minimal hydrogen crossover, even in embodiments in which the composite electrolyte membranes are typically thinner than state of the art electrolyzer composite membranes.

A recombination catalyst may also mitigate the degradation of the composite electrolyte membrane by radical species, such as peroxy or hydroxy radicals generated in or near the electrodes when the electrochemical device is a fuel cell. Such radical species are very active and may attack the components of the composite electrolyte membrane, thereby degrading it.

In embodiments of the first and second aspects, the recombination catalyst may be configured to be disposed adjacent to the first electrode forming the cathode of a fuel cell MEA. Within the context of this disclosure, adjacent to the cathode may mean that the recombination catalyst is closer to the cathode than to the anode in a MEA. A portion of the fuel cell composite membrane which is disposed adjacent to the cathode may be disposed in contact with the cathode. The recombination catalyst may be disposed in contact with a cathode.

The recombination catalyst may be a catalyst capable of catalysing the reaction between molecular hydrogen and molecular oxygen to produce water. In other words, the recombination catalyst may be a molecular hydrogen decomposition catalyst. The recombination catalyst may comprise a single recombination catalyst species or a mixture of recombination catalyst species. The recombination catalyst may comprise one or more catalytic species selected from: Pt, Ir, Ni, Co, Pd, Ti, Sn, Ta, Nb, Sb, Pb, Mn, and Ru, their oxides, and mixtures thereof. The recombination catalyst may comprise a platinum group metal (Group 10 metal) such as platinum, palladium, iridium, rhodium, ruthenium or osmium; alloys of platinum group metals; and mixed oxides of platinum group metals with other metals such as cerium and titanium, and mixtures thereof; or wherein the recombination catalyst comprises one or more of Pt, Ir, Ni, Co, Pd, Ti, Sn, Ta, Nb, Sb, Pb, Mn, and Ru, their oxides and mixtures thereof. The recombination catalyst may comprise a single recombination catalyst species or a mixture of recombination catalyst species. The recombination catalyst may be mixed with first ion exchange material. The recombination catalyst may be dispersed throughout the layer of first ion exchange material.

The recombination catalyst may be present on a recombination catalyst support material. The support material may comprise silica; zeolites; carbon; and oxides and carbides of the group IVB, VB, VIB VIIB, and VIII transition metals; and combinations thereof. Carbon is a particularly preferable support material. They preferably have high surface area, and so should be small in size, less than 75 nm, or preferably less than 50 nm, or less than 25 nm. They may also optionally be porous. The use of high surface area supports is particularly advantageous because it allows the recombination catalyst to be highly dispersed, leading to higher catalytic activity per unit weight compared with an unsupported, lower surface area catalysts of the same composition.

The recombination catalyst may be present at a loading of less than 0.1 mg/cm² in the composite electrolyte membrane. The recombination catalyst may be present at a loading in the range of from about 0.0001 mg/cm² to about 0.1 mg/cm², or from about 0.0005 mg/cm² to about 0.1 mg/cm², or from about 0.0008 mg/cm² to about 0.1 mg/cm², or from about 0.001 mg/cm² to about 0.1 mg/cm², or from about 0.0015 mg/cm² to about 0.1 mg/cm², or from about 0.002 mg/cm² to about 0.1 mg/cm², or from about 0.0025 mg/cm² to about 0.1 mg/cm², or from about 0.003 mg/cm² to about 0.1 mg/cm², or from about 0.0043 mg/cm² to about 0.0.005 mg/cm², or from about 0.0035 mg/cm² to about 0.1 mg/cm², or from about 0.005 mg/cm² to about 0.1 mg/cm², or from about 0.007 mg/cm² to about 0.1 mg/cm², or from about 0.009 mg/cm² to about 0.1 mg/cm², or from about 0.01 mg/cm² to about 0.1 mg/cm², or from about 0.04 mg/cm² to about 0.1 mg/cm², or from about 0.085 mg/cm² to about 0.1 mg/cm², or from about 0.013 mg/cm² to about 0.015 mg/cm², or from about 0.0001 mg/cm² to about 0.001 mg/cm², or from about 0.0001 mg/cm² to about 0.005 mg/cm², or from about 0.0001 mg/cm² to about 0.008 mg/cm², or from about 0.0001 mg/cm² to about 0.01 mg/cm², or from about 0.0001 mg/cm² to about 0.05 mg/cm², or from about 0.001 mg/cm² to about 0.01 mg/cm², or from about 0.004 mg/cm² to about 0.01 mg/cm², in the composite electrolyte membrane.

The recombination catalyst may be present in at least one layer of first ion exchange material at a loading of up to about 0.10 mg/cm², or at a loading in the range of from about 0.001 mg/cm² to about 0.09 mg/cm², or at a loading in the range of from about 0.006 mg/cm² to about 0.02 mg/cm².

In another embodiment of the first or second aspects, the first porous support and the second electrode may be separated i.e. the first porous support and the second electrode are not in contact. For instance, a layer, such as a second layer, of first ion exchange material may be present between the first porous support and the second electrode. The second layer of first ion exchange material may further comprise a recombination catalyst, such as a recombination catalyst as discussed above. The second layer of first ion exchange material may not contain a porous support, such that it is a second unreinforced layer of ion exchange material or a second unreinforced electrolyte layer. The second layer of first ion exchange material may be located between the reinforced electrolyte layer and the second electrode. A recombination catalyst may be present in the second layer of first ion exchange material when this will be in contact with a second electrode which is an anode. The second layer of unreinforced first ion exchange material may be free of second catalyst and optionally third ion exchange material. The composite electrolyte membrane may comprise such a second unreinforced electrolyte layer as part of the composite electrolyte. In another embodiment of the first or second aspects, the second porous support may be partially imbibed with the first catalyst and second ion exchange material. The region of the second porous support imbibed with first catalyst and second ion exchange material may be a layer, such that a reinforced electrode layer is provided.

In a further embodiment of the first or second aspects, the second porous support may also be partially imbibed with the first ion exchange material. The second porous support partially imbibed with the first ion exchange material may also be partially imbibed with a recombination catalyst, such as a recombination catalyst as discussed above for the first layer of first ion exchange material. A recombination catalyst may be present when the first electrode is an anode. For instance, a region of the second porous support may be imbibed with the first ion exchange material and optionally recombination catalyst. This region may be a layer of the second porous support imbibed with the first ion exchange material and optionally recombination catalyst. The first ion exchange material and optionally recombination catalyst imbibed into the second porous support may be in contact with a layer of first ion exchange material and optionally recombination catalyst between the first and second porous supports, or the first ion exchange material and optionally recombination catalyst imbibed into the second porous support may be in contact with the first ion exchange material at least partially imbibed into the first porous support. Thus, the first ion exchange material and optionally recombination catalyst imbibed into the second porous support and the layer of first ion exchange material (which may or may not further comprise a recombination catalyst) between the first and second porous supports may form a continuous phase. Alternatively, the first ion exchange material and optionally recombination catalyst imbibed into the second porous support and the first ion exchange material at least partially imbibed into the first porous support may form a continuous phase. The region or layer of the second porous support imbibed with the first ion exchange material and optionally recombination catalyst may be free of first catalyst and optionally second ion exchange material.

In another embodiment of the first or second aspects, the second porous support may be fully imbibed with the first catalyst and second ion exchange material. The second porous support fully imbibed with the first catalyst and the second ion exchange material provides a reinforced electrode layer.

In another embodiment of the first or second aspects, the first electrode may further comprise an unreinforced electrode layer comprising the first catalyst and second ion exchange material. The unreinforced electrode layer may be in contact with the reinforced electrode layer. The reinforced electrode layer may have a first side and an opposing second side. The first side of the reinforced electrode layer may be in contact with the composite electrolyte membrane. The unreinforced electrode layer may be in contact with the second side of the reinforced electrode layer. Thus, the unreinforced electrode layer may be located on the opposite side of the reinforced electrode layer to that of the composite electrolyte membrane. Thus, the reinforced electrode layer may be located between the unreinforced electrode layer and the composite electrolyte membrane.

In another embodiment of the first or second aspects, the first catalyst further comprises a catalyst support. The first catalyst may therefore be a supported first catalyst. The catalyst support may be a carbon particulate.

In another embodiment of the first or second aspects, the first catalyst comprises one or more of Pt, Ir, Ni, Co, Pd, Ti, Sn, Ta, Nb, Sb, Pb, Mn, Ru and Fe, their oxides, and mixtures thereof.

When the electrochemical device is a water electrolyzer, such devices may experience an unwanted side reaction between hydrogen and oxygen to form hydrogen peroxide (H₂O₂), which may decompose into peroxide radicals that can attack the composite electrolyte membrane and electrolyzer components. To mitigate this problem, the composite electrolyte membrane may further comprise an additive to decompose hydrogen peroxide and/or to eliminate the peroxide radicals. The additive may be a peroxide decomposition catalyst, a radical scavenger, a free radical decomposition catalyst, a self-regenerating antioxidant, a hydrogen donor primary antioxidant, a free radical scavenger secondary antioxidant, an oxygen absorbent, and the like. The additive may comprise Ce, Mn or their oxides. For example, the additive may be a cerium dioxide (ceria). For the avoidance of doubt, the additive may be added in addition to the recombination catalyst. The additive may be present in combination with the first ion exchange material, for instance the first layer of first ion exchange material may further comprise such an additive, and/or the second layer of first ion exchange material may further comprise such an additive, and/or such an additive may be imbibed into at least a portion of the first porous support with the first ion exchange material, and/or such an additive may be imbibed into a portion of the second porous support with the first ion exchange material.

In another embodiment of the first or second aspects, the second bubble point of the second porous support may be less than 100 kPa, 50 kPa or less, preferably 25 kPa or less, or 5 kPa or less.

In another embodiment of the first or second aspects, the first bubble point of the first porous support may be 100 kPa or more, may be 200 KPa or more, may be 300 kPa or more or may be 400 kPa or more, maybe 500 kPa.

In another embodiment of the first or second aspects, the difference between the bubble points of the first porous support and the second porous support is preferably at least 50 kPA, is at least 200 kPa, is at least 300 kPa or at least 350 kPa.

In another embodiment of the first or second aspects, the second porous support may have a second bubble point of less than 50 kPa and the first porous support may have a first bubble point of greater than 400 kPa.

In another embodiment of the first or second aspects, the second porous support has a mass per area of less than 3 g/m², preferably less than 1.5 g/m².

In another embodiment of the first or second aspects, the first porous support has a mass per area of less than 10 g/m², less than 5 g/m², or preferably less than 2.5 g/m².

In another embodiment of the first or second aspects, the composite electrolyte membrane comprises, in order, a first unreinforced electrolyte layer comprising first ion exchange material and optionally a recombination catalyst, and which is substantially free of first catalyst, a first reinforced electrolyte layer comprising first porous support at least partially imbibed with the first ion exchange material and optionally a recombination catalyst, and a second unreinforced electrolyte layer comprising first ion exchange material and optionally a recombination catalyst and which is substantially free of second catalyst, in which the first unreinforced electrolyte layer is in contact with the first electrode and the second unreinforced electrolyte layer is in contact with the second electrode.

The first ion exchange material and the second ion exchange material may be the same or different. In one embodiment of the first or second aspects, the first ion exchange material and the second ion exchange material may be the same. In one embodiment of the first or second aspects, the first ion exchange material and the second ion exchange material may be different.

In another embodiment of the first or second aspects, the second catalyst may further comprise a catalyst support. The second catalyst may therefore be a supported second catalyst. The catalyst support may be a carbon particulate.

In another embodiment of the first or second aspects, the second catalyst comprises one or more of Pt, Ir, Ni, Co, Pd, Ti, Sn, Ta, Nb, Sb, Pb, Mn, Ru and Fe, their oxides, and mixtures thereof.

In another embodiment of the first or second aspects, the ion exchange material, such as the first ion exchange material, the second ion exchange material or the third ion exchange material, independently comprises at least one ionomer. The at least one ionomer may comprise a proton conducting polymer. The proton conducting polymer may comprise perfluorosulfonic acid.

In another embodiment of the first or second aspects, the at least one ionomer may have a density not lower than about 1.9 g/cc at 0% relative humidity.

In another embodiment of the first or second aspects, the first ion exchange material and the second ion exchange material may be the same or different. In another embodiment of the first or second aspects, the first ion exchange material, the second ion exchange material and the third ion exchange material may be the same or different. As used herein, the term “same” indicates that the ion exchange materials have the same chemical structure and properties, such as equivalent weight. As used herein, the term “different” indicates that the ion exchange materials have different chemical structures and/or properties, such as equivalent weight.

In another embodiment of the first or second aspects, the porous support, such as the first porous support, and the second porous support may independently comprise a fluorinated polymer or a hydrocarbon polymer. The fluorinated polymer may be polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) or mixtures thereof. The fluorinated polymer is preferably expanded polytetrafluoroethylene (ePTFE). The hydrocarbon polymer may comprise polyethylene, polypropylene, polycarbonate, polystyrene, or mixtures thereof.

In another embodiment of the first or second aspects, the first electrode is a cathode, and the second electrode is an anode, for instance when the electrochemical device is a fuel cell.

In another embodiment of the first or second aspects, the first electrode is an anode, and the second electrode is a cathode, for instance when the electrochemical device is an electrolyzer.

In another embodiment of the first or second aspects, the membrane electrode assembly may further comprise a first gas diffusion layer in contact with the first electrode, wherein the first electrode is between the first gas diffusion layer and the composite electrolyte membrane.

In another embodiment of the first or second aspects, the membrane electrode assembly may further comprise a second gas diffusion layer in contact with the second electrode, wherein the second electrode is between the second gas diffusion layer and the composite electrolyte membrane.

In another embodiment of the first or second aspects, one or both of the first and second gas diffusion layers may be a porous carbon particle layer.

In another embodiment of the first or second aspects, there is provided an electrolyzer comprising the membrane electrode assembly of the first or second aspects and their embodiments. The first electrode may be a cathode, the first gas diffusion layer may be a porous transport layer and the second electrode may be an anode. Alternatively, the first electrode may be an anode, the second gas diffusion layer may be a porous transport layer and the second electrode may be a cathode.

In another embodiment of the first or second aspects, there is provided a fuel cell comprising the membrane electrode assembly of the first or second aspects and their embodiments. The first electrode may be a cathode and the second electrode may be a anode. Alternatively, the first electrode may be an anode and the second electrode may be a cathode.

In a third aspect, there is provided a composite electrolyte membrane, comprising:
a) at least one first porous support including a first porous support;
b) a second porous support; and
c) a first ion exchange material at least partially embedded within the first porous support to provide a reinforced electrolyte layer and to render the at least a part of first porous support occlusive; wherein
the second porous support comprises an un-imbibed region which is free of the first ion exchange material.

The embodiments of the first and second aspects are also applicable to the third aspect.

The first porous support at least partially imbibed with the first ion exchange material provides a reinforced electrolyte layer. In one embodiment the first porous support is substantially fully imbibed with the first ion exchange material. Thus, the first porous support may be rendered fully occlusive by the imbibed first ion exchange material. In another embodiment, the first porous support is partially imbibed with the first ion exchange material, such that a region, such as a layer, of the first porous support is imbibed with first ion exchange material and rendered occlusive.

The at least one first porous support may comprise a plurality of first porous supports. Each of the plurality of first porous supports may be at least partially imbibed with the first ion exchange material. Distributing the first support between two or more first porous supports may increase the resistance to piercing of the composite electrolyte membrane, such as by piercing from a fibrous diffusion layer or electrode component during manufacture of a membrane electrode assembly or electrochemical device. Adjacent first porous supports may be in contact, or they may be separated, for instance by a layer of first ion exchange material, for instance by a layer of first ion exchange material, such as an intermediate layer of first ion exchange material.

The composite electrolyte membrane may be used to produce the membrane electrode assembly.

In one embodiment of the third aspect, the first porous support and the second porous support are different porous supports. For instance, the first and second porous supports may be made of different materials with the same properties, may be made from the same material with different properties or may be made from different materials with different properties.

In another embodiment of the third aspect, the first porous support and the second porous support are the same porous support. For instance, the first and second porous supports may be made of the same material with the same properties. In some embodiments of the third aspect, the first and second porous support may be unitary.

In another embodiment of the third aspect, the composite electrolyte membrane comprises a first side and an opposing second side, wherein the first side is formed by the un-imbibed region of the second porous support.

In another embodiment of the third aspect, the outer surface of the un-imbibed region may form a first side of the composite electrolyte membrane.

In another embodiment of the third aspect, the first porous support has a first bubble point, and the second porous support has a second bubble point. In some embodiments of the third aspect, the first bubble point of the first porous support and the second bubble point of the second porous support may be the same. For instance, the first porous support and the second porous support may be made of the same material with the same properties. In other embodiments of the third aspect, the second bubble point of the second porous support may be less than the first bubble point of the first porous support.

In another embodiment of the third aspect, the second bubble point of the second porous support may be less than 100 kPa, may be 50 kPa or less, and preferably may be 25 kPa or less, or may be 5 kPa or less. In another embodiment of the third aspect, the first bubble point of the first porous support may be 100 kPa or more, may be 200 KPa or more, may be 300 kPa or more, may be 400 kPa or more or may be 500 kPa or more.

In another embodiment of the third aspect, the difference between the bubble points of the first porous support and the second porous support may be at least 50 kPa, may be at least 200 kPa, may be at least 300 kPa or may be at least 350 kPa.

In another embodiment of the third aspect, the second porous support may have a second bubble point of less than 50 kPa and the first porous support may have a first bubble point of greater than 400 kPa. In another embodiment, second porous support may have a second bubble point of less than 100 kPa and the first porous support may have a first bubble point of greater than 250 kPa.

In another embodiment of the third aspect, the second porous support has a mass per area of less than 3 g/m², preferably less than 1.5 g/m². In another embodiment, the first porous support has a mass per area of less than 10 g/m², or less than 5 g/m², and preferably less than 2.5 g/m².

The second porous support may have a mass per area of greater than 2 g/m² and the first porous support has a mass per area of less than 1.5 g/m².

In another embodiment of the third aspect, the first and second porous supports may not be in direct contact. In some embodiments of the third aspect, the composite electrolyte membrane further comprises at least one unreinforced electrolyte layer comprising first ion exchange material, such as a first unreinforced electrolyte layer comprising first ion exchange material. The at least one unreinforced electrolyte layer such as a first unreinforced electrolyte layer may further comprise a recombination catalyst, such as a recombination catalyst as discussed above. In embodiments of the third aspect, the reinforced electrolyte layer may have a first surface and an opposing second surface, and the first ion exchange material and optionally recombination catalyst may form a layer on one or both of the first surface and the second surface. In some embodiments of the third aspect at least one layer of first ion exchange material and optionally recombination catalyst is located between the first porous support and the second porous support. The unreinforced electrolyte layer, such as a first unreinforced electrolyte layer, may be in contact with the first porous support and the second porous support. It is preferred that the recombination catalyst is present in the unreinforced electrolyte layer which will be located closest to the anode when the composite electrolyte membrane is contacted with an anode.

In an alternative embodiment of the third aspect, the first porous support and the second porous support are in contact. The first porous support and the second porous support may be unitary i.e. have a unitary structure.

In another embodiment of the third aspect, the composite electrolyte membrane may further comprise a further unreinforced electrolyte layer comprising first ion exchange material, such as a second unreinforced electrolyte layer. The second unreinforced electrolyte layer may further comprise a recombination catalyst, such as a recombination catalyst as discussed above. One side of the second unreinforced electrolyte layer may be in contact with the first porous support, an opposite side of the second unreinforced electrolyte layer may form a second side of the composite electrolyte membrane. A recombination catalyst may be present in a second unreinforced electrolyte layer when this will be located closest to the anode when the composite electrolyte membrane is contacted with an anode.

In a further embodiment, the second porous support may also be partially imbibed with the first ion exchange material. The second porous support may also be partially imbibed with a recombination catalyst, such as a recombination catalyst discussed above. For instance, a region of the second porous support may be imbibed with the first ion exchange material and optionally a recombination catalyst. This region may be a layer of the second porous support imbibed with the first ion exchange material and optionally a recombination catalyst. The first ion exchange material and optionally recombination catalyst imbibed into the second porous support may be in contact with a layer of first ion exchange material and optionally recombination catalyst between the first and second porous supports, or the first ion exchange material and optionally recombination catalyst imbibed into the second porous support may be in contact with the first ion exchange material at least partially imbibed into the first porous support. Thus, the first ion exchange material and optionally recombination catalyst imbibed into the second porous support and the layer of first ion exchange material and optionally recombination catalyst between the first and second porous supports may form a continuous phase. Alternatively, the first ion exchange material and optionally recombination catalyst imbibed into the second porous support and the first ion exchange material at least partially imbibed into the first porous support may form a continuous phase. A recombination catalyst may be imbibed into the second porous support with the first ion exchange material when the second porous support is intended to anchor an anode as the first electrode.

The second porous support may also be partially imbibed with the first ion exchange material which is free of first catalyst. In embodiments, the second porous support is about less than 20%, or less than 10%, or less than 5% occluded with the first ion exchange material and optionally recombination catalyst. In another embodiment of the third aspect, the second porous support is substantially free of occluded portions and/or the first ion exchange material and optionally recombination catalyst, such that the second porous support is substantially free from a layer of the second porous support embedded with the first ion exchange material and optionally recombination catalyst.

In another embodiment of the third aspect, the first ion exchange material may comprise at least one ionomer. The at least one ionomer may comprise a proton conducting polymer. The proton conducting polymer may comprise perfluorosulfonic acid. The proton conducting polymer may comprise hydrocarbon ionomer, perfluorinated ionomer or perfluorosulfonic acid. The at least one ionomer may have a density not lower than about 1.9 g/cc at 0% relative humidity.

In another embodiment of a third aspect, the first porous support and the second porous support may independently comprise a fluorinated polymer or a hydrocarbon polymer. The fluorinated polymer may be selected from the group comprising polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) or mixtures thereof. The fluorinated polymer is preferably expanded polytetrafluoroethylene (ePTFE). The hydrocarbon polymer may comprise polyethylene, polypropylene, polycarbonate, polystyrene, or mixtures thereof.

In an embodiment for manufacture an MEA, the second porous support of the third aspect may be at least partially imbibed with a first electrode composition comprising second ion exchange material, the first catalyst and liquid carrier for forming a first electrode.

In another embodiment for manufacture an MEA, the second porous support of the third aspect may be fully imbibed or substantially fully imbibed with the first catalyst and second ion exchange material.

In a fourth aspect, there is provided a method for the manufacture of a membrane electrode assembly, said method comprising at least the steps of:
providing a composite electrolyte membrane with a first side and an opposing second side, said composite electrolyte membrane comprising a first porous support and a second porous support, the first porous support being at least partially imbibed with a first ion exchange material to provide a reinforced electrolyte layer; and the second porous support comprising an un-imbibed region which is substantially free of the first ion exchange material and defines the first side of the composite electrolyte membrane;
providing a first electrode composition comprising first catalyst, second ion exchange material and liquid carrier,
applying the first electrode composition to the first side of the composite electrolyte membrane and the un-imbibed region of the second porous support to at least partially imbibe the second porous support with the first catalyst and second ion exchange material to provide a first electrode composition imbibed second porous support;
heating the first electrode composition imbibed second porous support to remove liquid carrier from the first electrode composition to provide a first electrode with a reinforced electrode layer.

The embodiments of the first, second and third aspects are applicable to the fourth aspect.

In one embodiment of the fourth aspect, the second porous support is partially imbibed with the first ion exchange material, to provide a region of the second porous support imbibed with the first ion exchange material. In another embodiment of the fourth aspect, the region of the second porous support imbibed with the first ion exchange material is further imbibed with a recombination catalyst, such as a recombination catalyst discussed above. The region of the second porous support imbibed with the first ion exchange material and optionally a recombination catalyst may form the first side of the composite electrolyte membrane.

In another embodiment of the fourth aspect, the composite electrolyte further comprises a first unreinforced electrolyte layer comprising the first ion exchange material and optionally a recombination catalyst, the first unreinforced electrolyte layer located between the first porous support and the second porous support. The first unreinforced electrolyte layer may form the first side of the composite electrolyte membrane if there is no region of the second porous support imbibed with the first ion exchange material and optionally recombination catalyst.

In another embodiment of the fourth aspect, the composite electrolyte further comprises a second unreinforced electrolyte layer comprising the first ion exchange material and optionally a recombination catalyst, the first porous support being located between the second unreinforced electrolyte layer and the second porous support. The second unreinforced electrolyte layer may form a second side of the composite electrolyte membrane.

In embodiments of the fourth aspect, the reinforced electrode layer comprises second porous support imbibed with first catalyst and second ion exchange material.

In one embodiment of the fourth aspect, the second bubble point of the second porous support is less than the first bubble point of the first porous support.

In another embodiment of the fourth aspect, the step of applying the first electrode composition further provides a layer of first electrode composition on top of the first electrode composition imbibed second porous support, such that the step of heating of the first electrode composition imbibed second porous support provides an unreinforced electrode layer in contact with the reinforced electrode layer.

In another embodiment, wherein the composite electrolyte membrane has a second side opposite to that of the first side, and the method further comprises the steps of:
providing a second electrode composition comprising second catalyst, third ion exchange material and liquid carrier;
applying the second electrode composition to the second side of the composite electrolyte membrane to provide a layer of second electrode composition;
heating the layer of second electrode composition to remove liquid carrier from the layer of second electrode composition to provide a second electrode.

In embodiments of the fourth aspect, the second electrode comprises second catalyst and third ion exchange material.

In another embodiment of the fourth aspect, the method further comprises the steps of:
providing a first gas diffusion layer; and
applying the first gas diffusion layer to the first electrode such that the first electrode is between the first gas diffusion layer and the composite electrolyte membrane to provide a membrane electrode assembly comprising, in order, the first gas diffusion layer, the first electrode and the composite electrolyte membrane.

In another embodiment of the fourth aspect, the method further comprises the steps of:
providing a second gas diffusion layer; and
applying the second gas diffusion layer to the second electrode such that the second electrode is between the second gas diffusion layer and the composite electrolyte membrane to provide a membrane electrode assembly comprising, in order, the first gas diffusion layer, the first electrode, the composite electrolyte membrane, the second electrode and the second gas diffusion layer.

In a fifth aspect of this disclosure, there is provided a method for the manufacture of a composite electrolyte membrane, said method comprising at least the steps of:
providing a releasable backing layer;
applying a first electrolyte composition comprising first ion exchange material and liquid carrier as a layer of controlled thickness to the releasable backing layer in a single or multiple pas coating technique;
laminating a first porous support over at least a portion of the layer of the first electrolyte composition to at least partially imbibe the first porous support with first electrolyte composition to provide a first electrolyte composition imbibed first porous support;
heating the first electrolyte composition imbibed first porous support to remove liquid carrier to provide a reinforced electrolyte layer;
laminating a second electrolyte composition comprising first ion exchange material and liquid carrier over the reinforced electrolyte layer as a layer of controlled thickness in a single or multiple pass coating technique;
applying a second porous support over at least a portion of the layer of second electrolyte composition;
heating the second electrolyte composition to remove liquid carrier.

The embodiments of the first, second, third and fourth aspects are applicable to the fifth aspect.

In embodiments of the fifth aspect, heating the first electrolyte composition imbibed first porous support to remove liquid carrier provides a reinforced electrolyte layer comprising first porous support at least partially imbibed with first ion exchange material.

In embodiments of the fifth aspect, the applying a second porous support over at least a portion of the layer of second electrolyte composition partially imbibes the second porous support with second electrolyte composition to provide a second electrolyte composition imbibed second porous support.

In another embodiment of the fifth aspect, the second electrolyte composition may further comprise a recombination catalyst. Thus, in embodiments of the fifth aspect, the applying a second porous support over at least a portion of the layer of second electrolyte composition partially imbibes the second porous support with second electrolyte composition to provide a second electrolyte composition imbibed second porous support.

In embodiments of the fifth aspect, the heating of the second electrolyte composition to remove liquid carrier provides a second porous support partially imbibed with first ion exchange material. In embodiments of the fifth aspect when the second electrolyte composition further comprises a recombination catalyst, the heating of the second electrolyte composition to remove liquid carrier provides a second porous support partially imbibed with first ion exchange material and recombination catalyst.

In another embodiment of the fifth aspect, the step of applying the second electrolyte composition to the first side of the reinforced electrolyte layer provides a first layer of second electrolyte composition on the first side of the reinforced electrolyte layer.

In another embodiment of the fifth aspect, the step of heating the second electrolyte composition provides a composite electrolyte membrane further comprising a first unreinforced electrolyte layer comprising the first ion exchange material in contact with the reinforced electrolyte layer. In embodiments of the fifth aspect, when the second electrolyte composition further comprises a recombination catalyst, the heating of the second electrolyte composition provides a composite electrolyte membrane further comprising a first unreinforced electrolyte layer comprising the first ion exchange material and the recombination catalyst, in which the first unreinforced electrolyte layer is in contact with the reinforced electrolyte layer. The first unreinforced electrolyte layer may be located between the first porous support and the second porous support.

In another embodiment of the fifth aspect, the step of heating the first electrolyte composition imbibed first porous support to remove liquid carrier to provide a reinforced electrolyte layer further comprises the step of:
heating the layer of first electrolyte composition on the releasable backing layer to remove liquid carrier from the layer of first electrolyte composition to provide a second unreinforced electrolyte layer comprising first ion exchange material on the releasable backing layer.

In another embodiment of the fifth aspect, the first electrolyte composition may further comprise a recombination catalyst. In another embodiment of the fifth aspect, when the first electrolyte composition may further comprises a recombination catalyst, the step of heating the first electrolyte composition imbibed first porous support further comprises the step of:
heating the layer of first electrolyte composition on the releasable backing layer to remove liquid carrier from the layer of first electrolyte composition to provide a second unreinforced electrolyte layer comprising first ion exchange material and recombination catalyst on the releasable backing layer.

In another embodiment of the fifth aspect, the second unreinforced electrolyte layer may be located between the releasable backing layer and the reinforced electrolyte layer.

### BRIEF DESCRIPTION OF THE FIGURES

In the Figures, identical reference numerals have been used for the same or equivalent features of the composite electrolyte membranes, membrane electrode assemblies and processes disclosed herein.

FIG. 1 shows a schematic diagram of a membrane electrode assembly (MEA), the MEA comprising in order, a first electrode comprising a reinforced electrode layer, a composite electrolyte membrane comprising a reinforced electrolyte layer and a second electrode.

FIG. 2 shows a schematic diagram of a membrane electrode assembly (MEA), the MEA comprising in order, a first electrode comprising an unreinforced electrode layer and a reinforced electrode layer, a composite electrolyte membrane comprising a reinforced electrolyte layer and an unreinforced electrolyte layer, and a second electrode.

FIG. 3 shows a schematic diagram of a membrane electrode assembly (MEA), the MEA comprising in order, a first electrode comprising a reinforced electrode layer, a composite electrolyte membrane comprising a reinforced electrolyte layer and an unreinforced electrolyte layer, and a second electrode.

FIG. 4A shows a schematic diagram of a membrane electrode assembly (MEA) in another embodiment, the MEA comprising in order, a first electrode comprising an unreinforced electrode layer and a reinforced electrode layer, a composite electrolyte membrane comprising a reinforced electrolyte layer and an unreinforced electrolyte layer, and a second electrode.

FIG. 4B shows a schematic diagram of a membrane electrode assembly (MEA) in another embodiment, the MEA comprising in order, a first electrode comprising an unreinforced electrode layer and a reinforced electrode layer, a composite electrolyte membrane comprising a reinforced electrolyte layer having a recombination catalyst, a reinforced electrolyte layer and an unreinforced electrolyte layer, and a second electrode.

FIG. 5 shows a schematic diagram of a membrane electrode assembly (MEA), the MEA comprising in order, a first electrode comprising a reinforced electrode layer, a composite electrolyte membrane comprising a first unreinforced electrolyte layer, a reinforced electrolyte layer and a second unreinforced electrolyte layer, and a second electrode.

FIG. 6A shows a schematic diagram of a membrane electrode assembly (MEA), the MEA comprising in order, a first electrode comprising an unreinforced electrode layer and a reinforced electrode layer, a composite electrolyte membrane comprising a first unreinforced electrolyte layer, a reinforced electrolyte layer and a second unreinforced electrolyte layer; and a second electrode.

FIG. 6B shows a schematic diagram of a membrane electrode assembly (MEA), the MEA comprising in order, a first electrode comprising an unreinforced electrode layer and a reinforced electrode layer, a composite electrolyte membrane comprising a first unreinforced electrolyte layer comprising a recombination catalyst, a reinforced electrolyte layer and a second unreinforced electrolyte layer; and a second electrode.

FIG. 7 shows a schematic diagram of a membrane electrode assembly (MEA), the MEA comprising in order, a first electrode comprising an unreinforced electrode layer and a reinforced electrode layer, a composite electrolyte membrane comprising a reinforced electrolyte layer comprising a recombination catalyst, a first unreinforced electrolyte layer comprising a recombination catalyst, a reinforced electrolyte layer and a second unreinforced electrolyte layer; and a second electrode.

FIG. 8 shows a schematic diagram of a membrane electrode assembly (MEA) in another embodiment, the MEA comprising in order, a first electrode comprising an unreinforced electrode layer and a reinforced electrode layer, a composite electrolyte membrane comprising a reinforced electrolyte layer comprising a recombination catalyst, a reinforced electrolyte layer, an unreinforced electrolyte layer, a reinforced electrolyte layer and an unreinforced electrolyte layer, and a second electrode.

FIG. 9 shows a schematic diagram of a membrane electrode assembly (MEA) in another embodiment, the MEA comprising in order, a first electrode comprising an unreinforced electrode layer and a reinforced electrode layer, a composite electrolyte membrane comprising a reinforced electrolyte layer comprising a recombination catalyst, a reinforced electrolyte layer comprising a recombination catalyst, an unreinforced electrolyte layer, a reinforced electrolyte layer and an unreinforced electrolyte layer, and a second electrode.

FIG. 10 shows a schematic diagram of a composite electrolyte membrane in a first embodiment, comprising a porous support having a first porous support and a second porous support, the composite electrolyte membrane comprising in order, the second porous support and a reinforced electrolyte layer comprising the first porous support imbibed with first ion exchange material.

FIG. 11 shows a schematic diagram of the composite electrolyte membrane of FIG. 10 further comprising an unreinforced electrolyte layer on the opposite side of the reinforced electrolyte layer to that of the second porous support.

FIG. 12 shows a schematic diagram of a composite electrolyte membrane in another embodiment, comprising a porous support having a first porous support and a second porous support, the composite electrolyte membrane comprising in order, the second porous support partially imbibed with first ion exchange material and a reinforced electrolyte layer comprising the first porous support imbibed with first ion exchange material.

FIG. 13A shows a schematic diagram of a composite electrolyte membrane of FIG. 12 further comprising an unreinforced electrolyte layer on the opposite side of the reinforced electrolyte layer to that of the second porous support.

FIG. 13B shows a schematic diagram of a composite electrolyte membrane of FIG. 13A in which the second porous support is partially imbibed with first ion exchange material and a recombination catalyst.

FIG. 14A shows a schematic diagram of a composite electrolyte membrane in another embodiment, comprising a porous support having a first porous support and a second porous support, the composite electrolyte membrane comprising, in order, the second porous support, a first unreinforced electrolyte layer, a reinforced electrolyte layer and a second unreinforced electrolyte layer. The first unreinforced electrolyte layer is located between the first and second porous supports.

FIG. 14B shows a schematic diagram of a composite electrolyte membrane of FIG. 14A in which the first unreinforced electrolyte layer further comprises a recombination catalyst.

FIG. 15 shows a schematic diagram of a composite electrolyte membrane in another embodiment, said composite electrolyte membrane comprising a porous support having a first porous support and a second porous support, in which the first and the second porous support are the same type. The composite electrolyte membrane comprises, in order, the second porous support partially imbibed with first ion exchange material, a first unreinforced electrolyte layer, a reinforced electrolyte layer and a second unreinforced electrolyte layer.

FIG. 16A shows a schematic diagram of a composite electrolyte membrane in another embodiment, said composite electrolyte membrane comprising a porous support having a first porous support and a second porous support, the composite electrolyte membrane comprising, in order, the second porous support partially imbibed with first ion exchange material, a first unreinforced electrolyte layer comprising recombination catalyst, a reinforced electrolyte layer and a second unreinforced electrolyte layer.

FIG. 16B shows a schematic diagram of a composite electrolyte membrane of FIG. 16A in which the second porous support is partially imbibed with first ion exchange material and recombination catalyst.

FIG. 17 shows a schematic diagram of a porous support having a first porous support and second porous support in an embodiment according to this disclosure. The second porous support has a lower bubble point than that of the first porous support.

FIG. 18 shows a schematic diagram of a process for manufacturing composite electrolyte membranes according to this disclosure.

FIG. 19 shows a schematic diagram of a process for manufacturing a MEA comprising a composite electrolyte membrane and a first reinforced electrode according to this disclosure.

FIG. 20 shows a schematic diagram of a process for manufacturing a MEA comprising the composite electrolyte membrane with a first reinforced electrode according to FIG. 19 and a second electrode according to this disclosure.

FIG. 21 shows a schematic diagram of a process for manufacturing the MEA disclosed in FIGS. 19 and 20.

FIG. 22 is a cross-section made by scanning electron micrograph of the composite electrolyte membrane of Example 1.

FIG. 23 is a cross-section made by scanning electron micrograph of the electrode coated composite electrolyte membrane of Example 1.

### DETAILED DESCRIPTION

It will be apparent that various aspects of the present disclosure can be realized by any number of processes and apparatus configured to perform the intended functions. It should also be noted that the accompanying Figures referred to herein are not necessarily drawn to scale, and may be exaggerated to illustrate various aspects of the present disclosure, and in that regard, the figures should not be construed as limiting. Directional references such as “up,” “down,” “top,” “left,” “right,” “front,” and “back,” among others are intended to refer to the orientation as illustrated and described in the figure (or figures) to which the components and directions are referencing. Identical reference numerals in different Figures refer to identical features.

It is to be noted that all ranges described herein are exemplary in nature and include any and all values in between. The terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, or 10 percent, typically 10 percent. For a lower limit this represents the lower limit value minus the percentage of the lower limit and for an upper limit this represents the limit value plus the percentage of the lower limit.

In addition, all references cited herein are incorporated by reference in their entireties.

Various definitions used in the present disclosure are provided below.

As used herein, the term composite electrolyte membrane is used for an electrolyte membrane comprising a reinforced electrolyte layer. The reinforced electrolyte layer comprises at least one porous support, the porous support being at least partially imbibed with an ion exchange material. In embodiments, the electrolyte membrane may be a proton exchange membrane. In embodiments, the electrolyte membrane may be a polymer electrolyte membrane. In embodiments, the composite electrolyte membrane may be multilayered. Such a multilayered composite electrolyte membrane may comprise at least two porous supports (also referred to herein as “reinforcing layers or porous support”), each of the at least two porous supports being at least partially imbibed with ion exchange material. Such a multilayered composite electrolyte may comprise at least one layer of ion exchange material. The at least one layer of ion exchange material may be an unreinforced layer i.e. the at least one layer of ion exchange material may not comprise a porous support.

As used herein, a portion of a porous support, such as a first porous support or a second porous support, is referred to as rendered “occlusive” or “occluded” when the interior volume of that portion has structures that are characterized by a low volume of voids. For instance, a low volume of voids may be characterised by less than 10% voids by volume, and is highly impermeable to gas, as indicated by Gurley numbers larger than 10000 s for the imbibed portion of the first porous support. An occlusive portion of a porous support, such as the first porous support, is imbibed with the first ion exchange material which is free of any catalyst.

Conversely, the interior volume of a portion of a porous support is referred to as “non-occlusive” or “non-occluded” “when the interior volume of that portion has structures that are characterized by high volume of voids. For instance, a high volume of voids more than or equal to 10% by volume, and is permeable to gas, as indicated by Gurley numbers less than or equal to 10000 s. A non-occlusive portion or region of a porous support, such as the first or second porous support, may be substantially free of any ion exchange material. Alternatively, the non-occlusive portion may include a coating of ion exchange material to an internal surface of the porous support, such as the first or second porous support.

As used herein, the term “porous” refers to a structure having pores that are not visible to the naked eye. According to various optional embodiments, the pores may have an average pore size from 0.01 to 100 micrometers, e.g., from 0.05 to 20 micrometers or from 0.1 to 1 micrometer.

As used herein, the term “porous support” is intended to refer to a layer having a thickness of at least 0.1 micrometer, optionally from 0.5 to 100 or from 1 to 50 micrometers, or from 3 to 50 micrometers, or from 5 to 50 micrometers and having an average micropore size from 0.05 to 20 micrometers, e.g., from 0.1 to 1 micrometer.

As used herein, the term “unreinforced layer”, such as “unreinforced electrode layer” or “unreinforced electrolyte layer” is intended to mean a layer which does not contain a porous support. Such a layer comprises ion exchange material, and optionally further components, such as a catalyst.

As used herein, the term “unitary” porous support is intended to mean that the support forms a single entity, for instance an entity which cannot be separated into a first porous portion and a second porous portion without the destruction of the support. Thus, a unitary porous support may comprise first and second porous supports. The first porous support may comprise a first porous portion of the unitary support and the second porous support may comprise a second porous portion of the unitary support. The second porous portion of the unitary support has a second bubble point which is less than the first bubble point of the first porous portion.

As used herein, the terms “porous support” and “porous structure” are used interchangeably.

As used herein, the term “contact” takes the normal meaning of the state of physical touching i.e. direct contact.

As used herein, the term “first ion exchange material” is ion exchange material of the composite electrolyte membrane. This can be distinguished from the “second ion exchange material” which is ion exchange material present in the first electrode. Typically, the second ion exchange material is not present in the composite electrolyte membrane. However, the first ion exchange material may be present in the second porous layer forming a reinforced electrode layer. The “third ion exchange material” is the ion exchange material present in the second electrode. Typically, the third ion exchange material is not present in the composite electrolyte membrane.

### Membrane Electrode Assembly

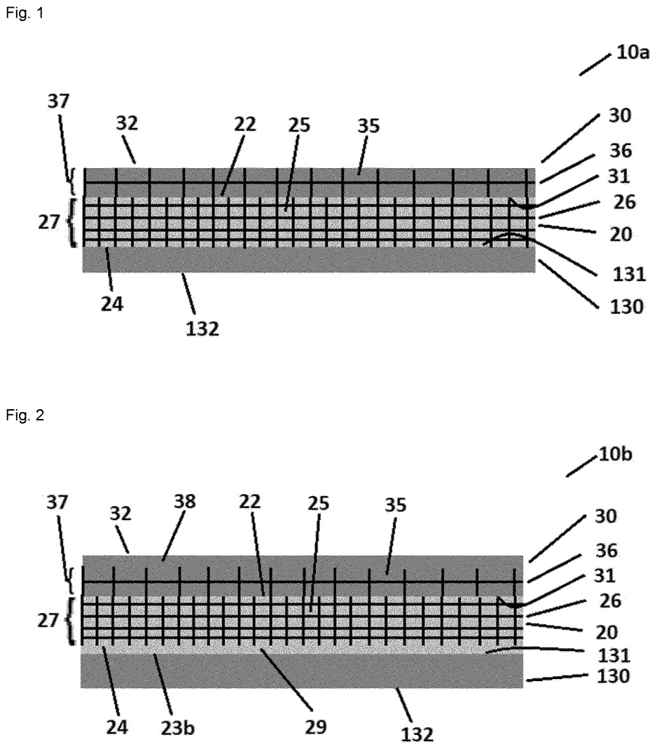

FIGS. 1-9 show schematic diagrams of membrane electrode assemblies 10a, b, c, d, e, f, g, h and i comprising a first electrode 30, a composite electrolyte membrane 20 and a second electrode 130.

FIG. 1 shows a schematic diagram of a membrane electrode assembly (MEA) 10a. The MEA 10a comprises in order, a first electrode 30, a composite electrolyte membrane 20 and a second electrode 130. The first electrode may be a cathode and the second electrode may be an anode. The first electrode 30 has a first side 31 and an opposing second side 32. In the embodiment of FIG. 1 the first electrode 30 comprises a reinforced electrode layer 37 with first side 31 and second side 32. The composite electrolyte membrane 20 comprises at least one porous support. In the embodiment of FIG. 1 the composite electrolyte membrane 20 comprises a first porous support 26 and a second porous support 36. The first porous support 26 being at least partially imbibed with a first ion exchange material 25 to provide a reinforced electrolyte layer 27. The reinforced electrolyte layer 27 has a first side 22 and an opposing second side 24. The second porous support 36 is at least partially imbibed with a second ion exchange material 35 and a first catalyst (not shown). In this way, at least a portion of the second ion exchange material 35 and first catalyst is impregnated into the pores of the second porous support 36 to provide a reinforced electrode layer 37. The reinforced electrode layer 37 comprising the second porous support 36 is at least partially imbibed with the second ion exchange material 35 and first catalyst. Thus, the second porous support 36 may form part of the first electrode 30. The first side 31 of the reinforced electrode layer 37 is in contact with the first side 22 of the reinforced electrolyte layer 27. The second porous support 36 improves the structural integrity of the first electrode 30 and can mitigate crack formation in the first electrode during drying to evaporate liquid carrier from the liquid first electrode composition applied to form the dried first electrode.

The pores of the second porous support 36 are at least partially and may be completely imbibed with second ion exchange material 35 and first catalyst. The second porous support 36 may be only partially imbibed with second ion exchange material 35 and first catalyst.

At least a portion of the first ion exchange material 25 is impregnated into the pores of the first porous support 26 providing the reinforced electrolyte layer 27. The reinforced electrolyte layer 27 therefore comprises the first porous support 26 at least partially imbibed with first ion exchange material 25. The first porous support 26 improves the structural integrity of the composite electrolyte membrane 20.

The pores of the first porous support 26 are at least partially and may be completely imbibed with first ion exchange material 25. The first porous support 26 fully imbibed with first ion exchange material 25 may be rendered occlusive. A first porous support 26 which is only partially imbibed with first ion exchange material 25 may be non-occlusive or comprise non-occlusive portions. Any non-occlusive portions of the first porous support 26 may be closest to one or both of the opposing first and second sides 22, 24 of the reinforced electrolyte layer 27.

The composite electrolyte membrane 20 may comprise at least one porous support. In one embodiment the porous support comprises a first porous support 26 and a second porous support 36. The first porous support 26 and the second porous support 36 may have the same or different porous structures. The first porous support 26 and the second porous support 36 may comprise same or different materials. In one embodiment the first porous structure 26 and the second porous structure 36 are different. Each of the porous structure is selected for impregnation of the specific ion exchange material for either the composite electrolyte membrane 20 or the first electrode 30. The second porous support 36 is selected for impregnation with the first catalyst to form reinforced electrode layer 37.

In one embodiment the first porous structure 26 and the second porous structure 36 are independent layers. In an alternative embodiment the first and second porous structure are unitary provided as an asymmetric porous structure, e.g. like an asymmetric porous membrane.

When the first porous support and the second porous support have different properties, the difference between the first porous structure and the second porous structure may be caused by, for example, a difference in pore size and/or a difference in density. In embodiments, the second porous structure 36 possesses a porous structure that is more “open” than the first porous structure 26. In one embodiment, the second porous structure 36 is considered to have an “open” porous structure and the first porous structure 26 is considered herein to have a “tight” porous structure. As used herein, the term “open” as opposed to “tight” means that the pore size of the “open” porous structure Is larger than that of the “tight” porous structure. A difference in pore size may be evidenced by bubble point or any suitable means for characterizing pore size.

In embodiments, the porous support, such as the first porous support 26 and the second porous support 36, may each independently have a bubble point i.e. a first and second bubble point respectively. The bubble point is a means to characterize the pore size of a porous support material and may be measured according to a bubble point measurement as further explained below. For a given fluid and pore size of a porous support or porous sheet at constant wetting, the pressure required to force an air bubble through the pore is in inverse proportion to the size of the pore (hole). The bubble point of a porous support material is not generally optimal for both, coating liquid electrolyte compositions in order to form a reinforced electrolyte layer after drying and coating liquid electrode compositions in order to form a reinforced electrode layer after drying. Consequently, the use of porous supports, e.g. porous polymer sheets conventionally used as reinforcement for a polymer composite electrolyte membrane having a relatively tight pore structure, poorly imbibe liquid electrode compositions.

These problems with imbibing porous supports with liquid electrolyte layer compositions and liquid electrode layer compositions can be mitigated by providing a first porous support with a first bubble point optimized for imbibing an electrolyte layer composition and a second porous support with a second bubble point optimized for imbibing an electrode layer composition. In particular, it is preferred that the second bubble point of the second porous support 36 is smaller than the first bubble point of the first porous support 26. In this context, the second porous support 36 may be referred to as having an “open” pore structure, whilst the first porous support 26 may be referred to as having an “tight” pore structure.

In one embodiment the first bubble point of the first porous support may be higher than the second bubble point of the second porous support. A porous structure with a higher bubble point may comprise smaller pores in contrast to a porous support with a lower bubble point which may comprise larger pores.

The first bubble point of the first porous support may be 100 kPa or more, may be 200 Kpa or more, may be 300 kPa or more or may be 400 kPa or more.

The second bubble point of the second porous support may be less than 100 kPa, may be 50 kPa or less, may be 25 kPa or less, or may be 5 kPa or less.

In another embodiment, the difference between the bubble point of the first porous support and the second porous support is preferably at least 50 kPA, is at least 200 kPa, is at least 300 kPa or at least 350 kPa.

In another embodiment, the second porous support may have a second bubble point of less than 50 kPa and the first porous support may have a first bubble point of greater than 400 kPa.

In another embodiment, the first porous support may have a mass per area of less than 10 g/m², less than 5 g/m², preferably less than 2.5 g/m².

In another embodiment, the second porous support may have a mass per area of less than 3 g/m², preferably less than 1.5 g/m².

Composite electrolyte membranes having first and second porous supports or structures and their various embodiments and properties are further described in relation to FIGS. 10 to 17.

The MEA 10a further comprises a second electrode 130 on the second side 24 of the reinforced electrolyte layer 27. In this way, the composite electrolyte membrane 20 is located between first electrode 30 and second electrode 130. The second electrode 130 has a first side 131 and an opposing second side 132.

The first side 131 of the second electrode 130 is in contact with the second side 24 of the reinforced electrolyte layer 27. Thus, the second electrode 130 is in contact with the first porous support 26.

The second electrode 130 may comprise a second catalyst and a third ion exchange material. The second catalyst may be the same as or different to the first catalyst, for instance in terms of the composition of the catalyst.

The ion exchange material of the first electrode, second electrode and composite electrolyte membrane, i.e. the first, second and third ion exchange materials, may independently be the same or different in terms of one or more of the chemical nature of the ion exchange material, its equivalent weight etc.

The catalyst loading of the first electrode 30 and second electrode 130, may independently be in the range of from 0.05 to 0.45 mg/cm², preferably in the range of from 0.1 to 0.4 mg/cm².

FIG. 2 provides an alternative membrane electrode assembly (MEA) 10b. The MEA 10b comprises in order, a first electrode 30, a composite electrolyte membrane 20 and a second electrode 130. The first electrode may be a cathode and the second electrode may be an anode. The MEA 10b differs from that of the MEA 10a of FIG. 1 in that the first electrode 30 further comprises an unreinforced electrode layer 38. The unreinforced electrode layer 38 may comprise the second ion exchange material 35 and first catalyst, i.e. the same electrode composition as the reinforced electrode layer 37 or it may comprise different ion exchange material and catalyst. The composite electrolyte membrane 20 further comprises an unreinforced electrolyte layer 29 comprising first ion exchange material 25, which may be an unreinforced electrolyte layer located between the reinforced electrolyte layer 27 and the second electrode 130.

The unreinforced electrode layer 38 may lie on top of the first reinforced electrode layer 37 and one side of the unreinforced electrode layer 38 may form the second side 32 of the first electrode 30.

In some embodiments, the unreinforced electrode layer 38 may be formed during manufacture of the MEA. In such an embodiment the electrode composition of second ion exchange material 35 and first catalyst is applied in such an amount that the second porous support 36 is fully imbibed providing the reinforced electrode layer 37 and the additional electrode composition forms unreinforced electrode layer 38 on top of the first reinforced electrode layer 37.

In such an embodiment, the ion exchange material and first catalyst of the first electrode 30, e.g. the second ion exchange material 35 and first catalyst of the first reinforced electrode layer 37 and the first catalyst and second ion exchange material of the unreinforced electrode layer 38 may form a continuous phase. As used herein, the term “continuous phase” means that the second ion exchange material 35 of the first electrode 30 is free from internal interfaces. In some embodiments, the unreinforced electrode layer 38 may be applied during manufacture of the MEA as separate layer.

In some embodiments the second porous support 36 is partially imbibed with second ion exchange material 35 and first catalyst and provides non-occlusive portions in the top surface area of the second porous support providing an anchoring effect for the second ion exchange material and first catalyst of the unreinforced electrode layer 38 when the unreinforced electrode layer 38 may be applied during manufacture of the MEA as separate layer.

In addition to the reinforced electrolyte layer 27, the composite electrolyte membrane 20 may further comprise an unreinforced electrolyte layer 29 comprising first ion exchange material. The unreinforced electrolyte layer 29 may be in contact with the first porous support 26. The unreinforced electrolyte layer 29 may lie on the second side 24 of the reinforced electrolyte layer 27.

In some embodiments, the ion exchange material of the composite electrolyte membrane 20, e.g. the first ion exchange material 25 of the reinforced electrolyte layer 27 and the first ion exchange material of the second unreinforced electrolyte layer 29 may form a continuous phase. As used herein, the term “continuous phase” means that the ion exchange material of the composite electrolyte membrane 20 is free from internal interfaces.

In embodiments, only one of the unreinforced electrolyte layer 29 and unreinforced electrode layer 38 may be present.

The MEA 10b further comprises a second electrode 130 on a second side 23b of the composite electrolyte membrane 20. In this way, the composite electrolyte membrane 20 is located between first electrode 30 and second electrode 130. The second electrode 130 has a first side 131 and an opposing second side 132.

The first side 131 of the second electrode 130 is in contact with the second side 23b of the composite electrolyte membrane 20. Thus, the second electrode 130 is in contact with the unreinforced electrolyte layer 29. The second electrode 130 comprises third ion exchange material and second catalyst

The second catalyst of the second electrode 130 may be the same as or different to the first catalyst of the first electrode 30, for instance in terms of the composition of the catalyst.

The ion exchange material of the first electrode 30, second electrode 130 and composite electrolyte membrane 20, i.e. the first, second and third ion exchange materials, may independently be the same or different in terms of one or more of the chemical nature of the ion exchange material, its equivalent weight etc.

The remaining features of the MEA 10b of FIG. 2 may be as described for the same features of the MEA 10a of FIG. 1.

In the MEAs 10a, 10b of FIGS. 1 and 2, the first porous support 26 is in contact with the second porous support 36. In some embodiments, the first porous support 26 and the second porous support 36 can be provided as a unitary porous support. Such a unitary porous support may have portions with different bubble points, corresponding to first porous support 26 and second porous support 36. For instance, the first porous support may have a higher bubble point than the second porous support.

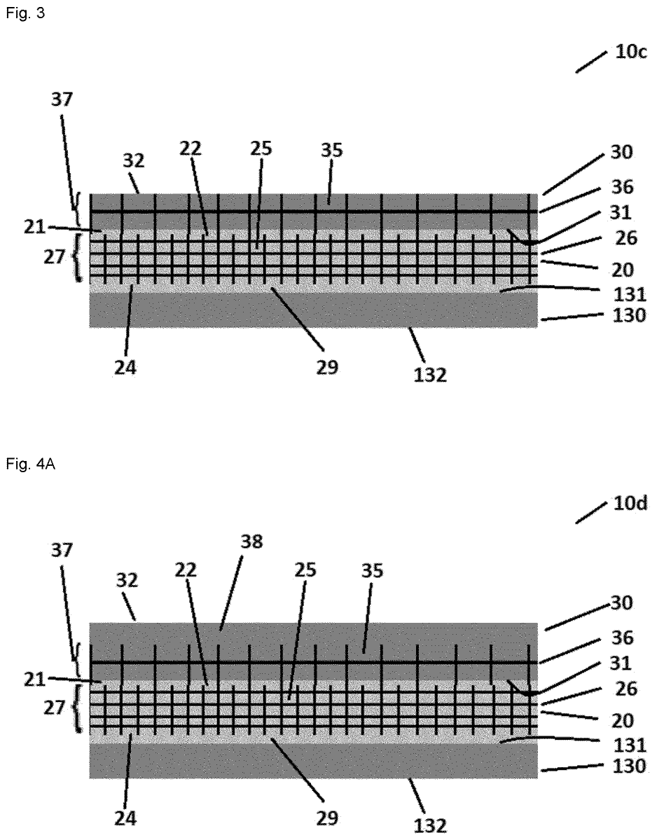

FIG. 3 provides an alternative membrane electrode assembly 10c. The MEA 10c comprises in order, a first electrode 30, a composite electrolyte membrane 20 and a second electrode 130. The first electrode may be a cathode and the second electrode may be an anode. The first electrode 30 comprises a reinforced electrode layer 37 comprising second porous support 36 imbibed at least partially with first catalyst and second ion exchange material 35. The MEA 10c differs from that of the MEA 10a of FIG. 1 in that a portion of the second porous support 36 is also imbibed with a layer 21 of first ion exchange material which is substantially free of the first catalyst. The composite electrolyte membrane 20 further comprises a second unreinforced electrolyte layer 29 comprising first ion exchange material 25.

In this embodiment the composite electrolyte membrane 20 comprises a layer 21 of first ion exchange material on top of the first side 22 of reinforced electrolyte layer 27. The layer 21 of first ion exchange material is substantially free of the first catalyst. The first porous support 26 and the second porous support 36 are in contact whereby the second porous support 36 is partially imbibed with the ion exchange material to form the layer 21 of first ion exchange material. The extension of the first ion exchange material 25 from the reinforced electrolyte layer 27 into a portion (e.g. a bottom portion) of the second porous support 36 can anchor the second porous support 36 as component of the composite electrolyte membrane. In one embodiment the first ion exchange material 25 may imbibe a bottom portion of the second porous support 36 and keep the remaining main portion of the second porous support 36 un-imbibed and therefore free of the first ion exchange material.

The electrode reinforced layer 37 comprises the second porous support 26 partially imbibed with first catalyst and second ion exchange material 35. The reinforced electrode layer 37 may have a side which forms the first side 31 of the first electrode 30. The first side 31 of the reinforced electrode layer 37 is in contact with layer 21 of first ion exchange material. Thus, the second porous support 36 is fully imbibed with two different layers of ion exchange material, the first ion exchange material 25 imbibes the bottom portion of the second porous support 36 and the second ion exchange material 35 and first catalyst mainly imbibe the remaining major portion of the second porous support 36.

The second catalyst of the second electrode 130 may be the same as or different to the first catalyst of the first electrode 30, for instance in terms of the composition of the catalyst.

The ion exchange material of the first electrode 30, second electrode 130 and electrolyte 20, i.e. the first, second and third ion exchange materials, may independently by the same or different in terms of one or more of the chemical nature of the ion exchange material, its equivalent weight etc.

The remaining features of the MEA 10c of FIG. 3 may be as described for the same features of the MEAs 10a, 10b of FIGS. 1 and 2.

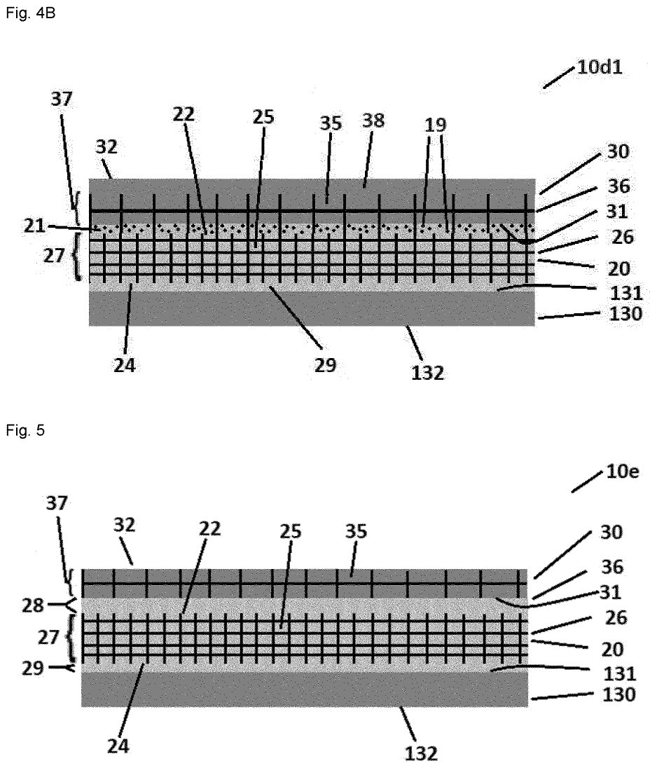

FIG. 4A provides an alternative membrane electrode assembly (MEA) 10d. The MEA 10d comprises in order, a first electrode 30, a composite electrolyte membrane 20 and a second electrode 130. The first electrode may be a cathode and the second electrode may be an anode. The MEA 10d differs from that of the MEA 10c of FIG. 3 in that the first electrode 30 further comprises an unreinforced electrode layer 38 comprising first catalyst and second ion exchange material 35.

Thus, in addition to the reinforced electrode layer 37, the first electrode 30 may further comprise an unreinforced electrode layer 38. In one embodiment, the reinforced electrode layer 37 comprising first catalyst and second ion exchange material 35 may thus be in contact with the unreinforced electrode layer 38. Thus, one side of the unreinforced electrode layer 38 may form the second side 32 of the first electrode 30. The unreinforced electrode layer 38 may comprise second catalyst and second ion exchange material.

In some embodiments, the first catalyst and second ion exchange material of the first electrode 30, e.g. the first catalyst and second ion exchange material 35 of the reinforced electrode layer 37 and the first catalyst and second ion exchange material 35 of the unreinforced electrode layer 38 may form a continuous phase. The second porous support 36 at least partially imbibed with first catalyst and second ion exchange material 35 can provide an anchoring effect for the unreinforced electrode layer 38 comprising first catalyst and second ion exchange material.

The second catalyst of the second electrode 130 may be the same as or different to the first catalyst of the first electrode 30, for instance in terms of the composition of the catalyst.

The ion exchange material of the first electrode 30, second electrode 130 and composite electrolyte membrane 20, i.e. first, second and third ion exchange materials, may independently be the same or different in terms of one or more of the chemical nature of the ion exchange material, its equivalent weight etc.

The remaining features of the MEA 10d of FIG. 4A may be as described for the same features of the previous MEAs 10a-10c of FIGS. 1-3.

FIG. 4B provides an alternative membrane electrode assembly (MEA) 10d1 to that of FIG. 4A. The MEA 10d1 comprises in order, a first electrode 30, a composite electrolyte membrane 20 and a second electrode 130. The MEA 10d1 differs from that of the MEA 10d of FIG. 4A in that the layer 21 of first ion exchange material on top of the first side 22 of reinforced electrolyte layer 27 further comprises a recombination catalyst 19.

The second porous support 36 is configured to have a pore size sufficiently large to admit the recombination catalyst. The first porous support 26 may be configured to have a pore size which is too small to admit the recombination catalyst. This is reflected in the second porous support 36 having a lower bubble point that that of the first porous support 26.

The membrane electrode assembly of FIG. 4B may be a fuel cell membrane electrode assembly in which the first electrode 30 may be a cathode and the second electrode 130 may be an anode. The recombination catalyst in the layer 21 of first ion exchange material and recombination catalyst imbibed into a portion of the second porous support 36 may have a loading of about 0.02 mg/cm².

The remaining features of the MEA 10d1 of FIG. 4B may be as described for the same features of the previous MEAs 10a-10d of FIGS. 1-4A.

FIG. 5 provides an alternative membrane electrode assembly (MEA) 10e. The MEA 10e comprises in order, a first electrode 30, a composite electrolyte membrane 20 and a second electrode 130. The first electrode may be a cathode and the second electrode may be an anode. The MEA 10e differs from that of the MEA 10a of FIG. 1 in that the composite electrolyte membrane 20 comprises two unreinforced electrolyte layers comprising first ion exchange material, first unreinforced electrolyte layer 28 and second unreinforced electrolyte layer 29. The first unreinforced electrolyte layer 28 and second unreinforced electrolyte layer 29 may lie on either side of the reinforced electrolyte layer 27.

The second unreinforced electrolyte layer 29 may be in contact with the first porous support 26. The first unreinforced electrolyte layer 28 may lie between the first porous support 26 and the second porous support 36. The first unreinforced electrolyte layer 28 may be in contact with the first porous support 26 and second porous support 36.

The first porous support 26 at least partially imbibed with first ion exchange material 25 can provide an anchoring effect for the first unreinforced electrolyte layer 28 comprising first ion exchange material 25.

The second unreinforced electrolyte layer 29 may be in contact with the first porous support 26. The second unreinforced electrolyte layer 29 may lie between the first porous support 26 and the second electrode 130. The second unreinforced electrolyte layer 29 may be in contact with the second electrode 130.

In some embodiments, the first ion exchange material of the composite electrolyte membrane 20, e.g. the first ion exchange material 25 of the reinforced electrolyte layer 27 and the first and second unreinforced electrolyte layers 28, 29 may form a continuous phase. Thus, the first ion exchange material of the composite electrolyte membrane 20 may be free from any internal interfaces.

The second catalyst of the second electrode 130 may be the same as or different to the first catalyst of the first electrode 30, for instance in terms of the composition of the catalyst.

The ion exchange material of the first electrode 30, second electrode 130 and composite electrolyte membrane 20, i.e. the first, second and third ion exchange materials, may independently be the same or different in terms of one or more of the chemical nature of the ion exchange material, its equivalent weight etc.

The remaining features of the MEA 10e of FIG. 5 may be as described for the same features of the MEAs 10a-10d of FIGS. 1-4B.

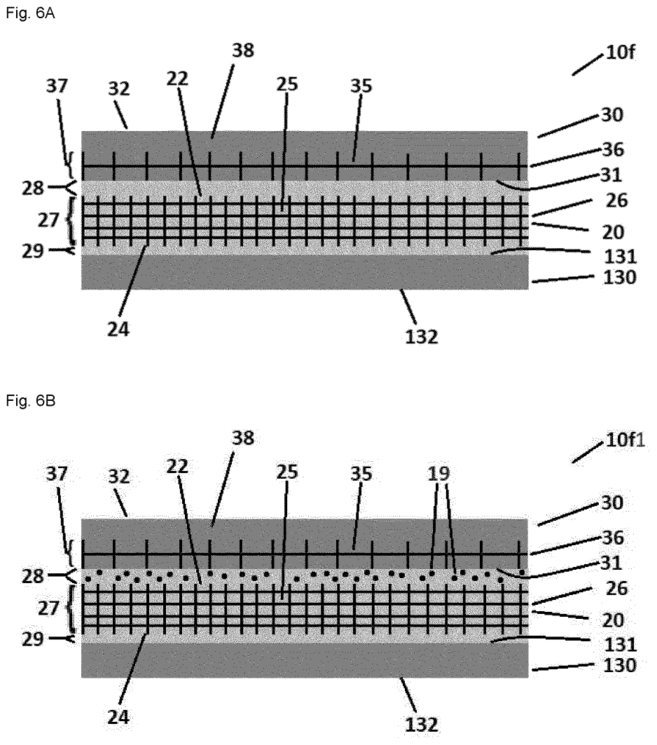

FIG. 6A provides an alternative membrane electrode assembly (MEA) 10f. The MEA 10f comprises in order, a first electrode 30, a composite electrolyte membrane 20 and a second electrode 130. The first electrode may be a cathode and the second electrode may be an anode. The MEA 10f differs from that of the MEA 10e of FIG. 5 in that the first electrode 30 further comprises an unreinforced electrode layer 38 comprising first catalyst and second ion exchange material.

Thus, in addition to the reinforced electrode layer 37, the first electrode 30 may further comprise an unreinforced electrode layer 38 on the second porous support 36. The reinforced electrode layer 37 comprising second porous support 36 imbibed with first catalyst and second ion exchange material 35 may thus be in contact with the unreinforced electrode layer 38. Thus, one side of the unreinforced electrode layer 38 may form the second side 32 of the first electrode 30, with the first side 31 of the first electrode 30 being formed by the side of the reinforced electrode layer 37 in contact with the first unreinforced electrolyte layer 28.

In some embodiments, the first catalyst and second ion exchange material of the first electrode 30, e.g. the first catalyst and second ion exchange material 35 of the reinforced electrode layer 37 and the first catalyst and second ion exchange material of the unreinforced electrode layer 38 may form a continuous phase. The second porous support 36 at least partially imbibed with first catalyst and second ion exchange material 35 can provide an anchoring effect for the unreinforced electrode layer 38 comprising first catalyst and second ion exchange material.

The second catalyst of the second electrode 130 may be the same as or different to the first catalyst of the first electrode 30, for instance in terms of the composition of the catalyst.

The ion exchange material of the first electrode 30, second electrode 130 and electrolyte 20, i.e. the first, second and third ion exchange materials, may independently by the same or different in terms of one or more of the chemical nature of the ion exchange material, its equivalent weight etc.

The remaining features of the MEA 10f of FIG. 6A may be as described for the same features of the previous MEAs 10a-10e of FIGS. 1-5.

FIG. 6B provides an alternative membrane electrode assembly (MEA) 10f1 to that of FIG. 6A. The MEA 10f1 comprises in order, a first electrode 30, a composite electrolyte membrane 20 and a second electrode 130. The first electrode may be an anode and the second electrode may be a cathode. The MEA 10f1 differs from that of the MEA 10f of FIG. 6A in that the first unreinforced electrolyte layer 28 further comprises a recombination catalyst 19.

The first and second porous supports 26, 36 may be configured to have a pore size which is too small to admit the recombination catalyst in the first unreinforced electrolyte layer 28.

The remaining features of the MEA 10f1 of FIG. 6B may be as described for the same features of the previous MEAs 10a-10f of FIGS. 1-6A.

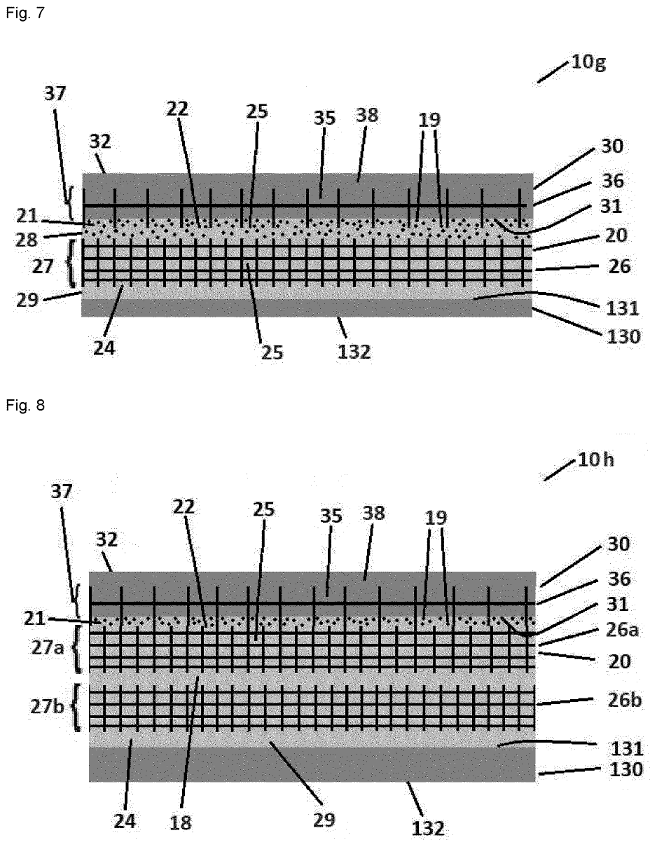

FIG. 7 provides an alternative membrane electrode assembly (MEA) 10g. The MEA 10g comprises in order, a first electrode 30, a composite electrolyte membrane 20 and a second electrode 130. The MEA 10g differs from that of the MEA 10f1 of FIG. 6B in that a portion of the second porous support 36 is also imbibed with a layer 21 of first ion exchange material and recombination catalyst 19 which is substantially free of the first catalyst.

In this embodiment the composite electrolyte membrane 20 further comprises a layer 21 of first ion exchange material on top of the first unreinforced electrolyte layer 28. The layer 21 of first ion exchange material is substantially free of the first catalyst. The second porous support 36 is partially imbibed with the first ion exchange material and recombination catalyst to form the layer 21. The extension of the first ion exchange material 25 from the first unreinforced electrolyte layer 28 into a portion (e.g. a bottom portion) of the second porous support 36 can anchor the second porous support 36 as a component of the composite electrolyte membrane. In one embodiment the first ion exchange material 25 and recombination catalyst 19 may imbibe a bottom portion of the second porous support 36 and keep the remaining main portion of the second porous support 36 un-imbibed and therefore free of the first ion exchange material and recombination catalyst.

Thus, recombination catalyst is present in the first unreinforced electrolyte layer 28 which is located between the first and second porous supports 26, 36 and the layer 21 of ion exchange material imbibed into the second porous support 36, providing a thicker region of the composite electrolyte membrane containing recombination catalyst.

The membrane electrode assembly of FIG. 7 may be a fuel cell membrane electrode assembly in which the first electrode 30 may be a cathode and the second electrode 130 may be an anode. The recombination catalyst in the first unreinforced electrolyte layer 28 and the layer 21 of first ion exchange material and recombination catalyst imbibed into a portion of the second porous support 36 may have a loading of about 0.02 mg/cm².

The remaining features of the MEA 10g of FIG. 7 may be as described for the same features of the previous MEAs 10a-10f1 of FIGS. 1-6B.

FIG. 8 provides an alternative membrane electrode assembly (MEA) 10h. The MEA 10h comprises in order, a first electrode 30, a composite electrolyte membrane 20 and a second electrode 130. The MEA 10h differs from that of the MEA 10d1 of FIG. 4B in that the composite electrolyte membrane comprises a further (second) reinforced electrolyte layer 27b. Thus, MEA 10h comprises two first porous supports.

The composite electrolyte membrane comprises the reinforced electrolyte layer (cf. 27 of FIGS. 1-7) which is a first reinforced electrolyte layer 27a and a second reinforced electrolyte layer 27b. The first reinforced electrolyte layer 27a comprises a (first) first porous layer 26a at least partially impregnated with first ion exchange material 25. The second reinforced electrolyte layer 27b comprises a (second) first porous layer 26b at least partially impregnated with first ion exchange material 25.

The (first) first reinforced electrolyte layer 27a has on one side a layer 21 of first ion exchange material and recombination catalyst. The layer 21 of first ion exchange material and recombination catalyst is substantially free of the first catalyst. The second porous support 36 is partially imbibed with the first ion exchange material and recombination catalyst to form the layer 21, which is a reinforced electrolyte layer. The (first) first reinforced electrolyte layer 27a has on the opposing side an intermediate layer of first ion exchange material 18.

The first and second reinforced electrolyte layers 27a, 27b are separated by the intermediate layer of first ion exchange material 18. The intermediate layer of ion exchange material 18 does not contain a porous support, and is an intermediate unreinforced electrolyte layer 18.

The (second) first reinforced electrolyte layer 27b has on one side the intermediate unreinforced electrolyte layer 18. The (second) first reinforced electrolyte layer 27b has on the opposing side a layer of first ion exchange material 29. The layer of ion exchange material 29 does not contain a porous support, and is a second unreinforced electrolyte layer 29.

The membrane electrode assembly of FIG. 8 may be a fuel cell membrane electrode assembly in which the first electrode 30 may be a cathode and the second electrode 130 may be an anode. The layer 21 of first ion exchange material and recombination catalyst imbibed into the second porous support 36 may have a loading of recombination catalyst of about 0.02 mg/cm².

The remaining features of the MEA 10h of FIG. 8 may be as described for the same features of the previous MEAs 10a-10g of FIGS. 1-7.

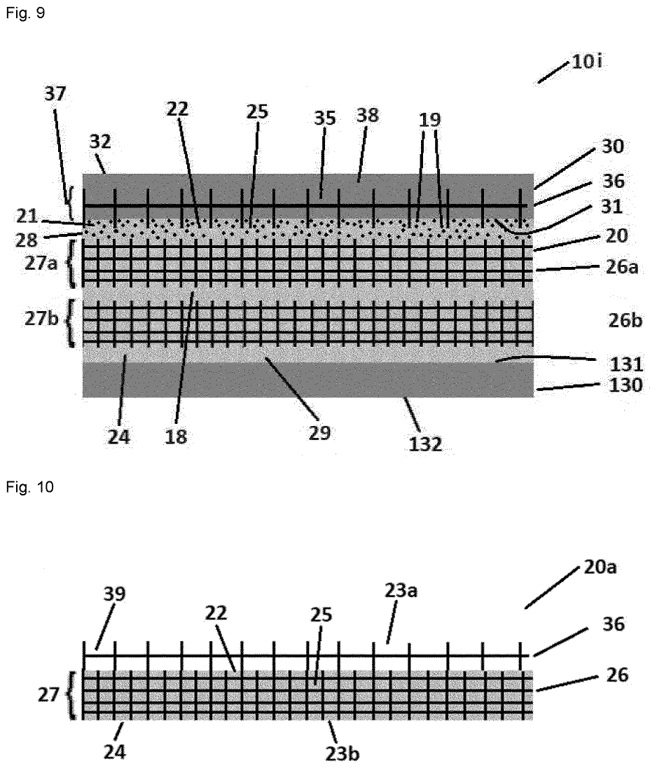

FIG. 9 provides an alternative membrane electrode assembly (MEA) 10i. The MEA 10i comprises in order, a first electrode 30, a composite electrolyte membrane 20 and a second electrode 130. The MEA 10i differs from that of the MEA 10g of FIG. 8 in that the composite electrolyte membrane comprises a further (first) unreinforced electrolyte layer 28 comprising a recombination catalyst.

The (first) first reinforced electrolyte layer 27a has on one side a layer 28 of first ion exchange material and recombination catalyst. The layer 28 of first ion exchange material and recombination catalyst does not contain a porous support, and is a first unreinforced electrolyte layer 28. The (first) first reinforced electrolyte layer 27a has on the opposing side the intermediate layer of first ion exchange material 18.

The (second) first reinforced electrolyte layer 27b has on one side the intermediate unreinforced electrolyte layer 18. The (second) first reinforced electrolyte layer 27b has on the opposing side a layer 29 of first ion exchange material. The layer of ion exchange material 29 does not contain a porous support, and is a second unreinforced electrolyte layer 29.

The membrane electrode assembly of FIG. 9 may be a fuel cell membrane electrode assembly in which the first electrode 30 may be a cathode and the second electrode 130 may be an anode. The recombination catalyst in the first unreinforced electrolyte layer 28 and the layer of first ion exchange material and recombination catalyst imbibed into a portion of the second porous support 36 may have a loading of about 0.02 mg/cm².

The remaining features of the MEA 10i of FIG. 9 may be as described for the same features of the previous MEAs 10a-10h of FIGS. 1-8.

A gas diffusion layer (GDL) can be added to each electrode. Such an MEA comprises in order, a first gas diffusion layer, a first electrode, a composite electrolyte membrane, a second electrode and a second gas diffusion layer. The first GDL may have a first side and an opposing second side. The second GDL may have a first side and an opposing second side. The first side of the first GDL may be in contact with the second side of the first electrode layer. The first side of the second GDL may be in contact with the second side of the second GDL.

The first and second gas diffusion layers may independently comprise a porous carbon particle layer, such as microporous carbon paper.

The membrane electrode assemblies comprising such gas diffusion layers may be fuel cell membrane electrode assemblies.

The membrane electrode assemblies may also be electrolyzer membrane electrode assemblies when one of the first and second gas diffusion layers is a porous transport layer.

An electrolyzer may be provided with an MEA as described herein, such as an MEA 10 as described having gas diffusion layers in which one of the first and second gas diffusion layers is a porous transport layer.

A fuel cell may be provided with an MEA as described herein, such as an MEA 10 as described having gas diffusion layers.

### Composite Electrolyte Membranes

The following composite electrolyte membranes can be used in the manufacture of the MEAs, electrolyzers and fuel cells disclosed herein.

FIG. 10 shows a schematic diagram of a composite electrolyte membrane 20a according to this disclosure. In one embodiment, the composite electrolyte membrane 20a can be used to manufacture MEA 10a of FIG. 1. Composite electrolyte membrane 20a comprises a first porous support 26 and a second porous support 36. The first porous support 26 is at least partially imbibed with first ion exchange material 25 providing reinforced electrolyte layer 27. The second porous support 36 is not imbibed with first ion exchange material and therefore presents a substantially un-imbibed porous structure or an unimbibed region. During the manufacture of a MEA the second porous support 36 may become part of the first electrode as an electrode porous support when electrode composition has been applied to the first side 23a of composite electrolyte membrane 20 providing a first reinforced electrode.

The first ion exchange material 25 is impregnated into the pores of the first porous support 26 to provide the reinforced electrolyte layer 27. The reinforced electrolyte layer 27 therefore comprises the first porous support 26 at least partially imbibed with first ion exchange material 25. The first porous support 26 improves the structural integrity of the composite electrolyte membrane 20a and can mitigate swelling of the electrolyte during drying to evaporate liquid carrier from the liquid first electrode composition applied to form the dried first electrode.

The pores of the first porous support 26 may be completely imbibed with first ion exchange material 25. The first porous support 26 fully imbibed with ion exchange material 25 may be rendered occlusive.

The composite electrolyte membrane 20 may comprise at least one porous support. In one embodiment the porous support comprises a first porous support 26 and a second porous support 36. The first porous support 26 and the second porous support 36 may have the same or different porous structures. The first porous support 26 and the second porous support may comprise same or different materials.

In one embodiment the first porous structure 26 and the second porous structure 36 are different. Each of the porous structure is selected for impregnation of the specific ion exchange material for either the composite electrolyte membrane 20 or the first electrode 30. The second porous support 36 forming the first reinforced electrode 37 is also selected for impregnation of the first catalyst. In one embodiment the first porous structure 26 and the second porous structure are independent layers.

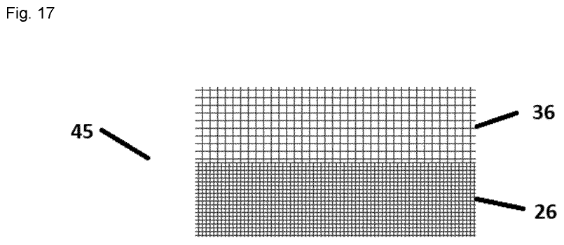

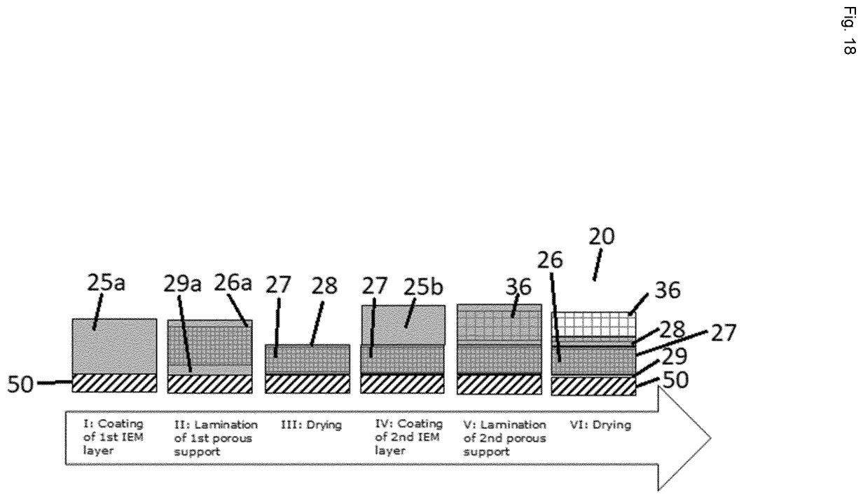

In an alternative embodiment the first and second porous structure are unitary, and may be provided as an asymmetric porous structure, e.g. like an asymmetric porous membrane. In some embodiments, the first porous support 26 and the second porous support 36 can be provided as a unitary porous support. Such a unitary porous support may have portions with different bubble points, corresponding to first porous support 26 and second porous support 36. A unitary porous support can be prepared by laminating first and second porous support to each other. In various embodiments a unitary porous support may manufacture according to U.S. Pat. No. 5,225,131 or 4,478,665. An embodiment of an asymmetric porous support is shown in FIG. 17 of the present disclosure.

The difference between the first porous structure 26 and the second porous structure 36 may be caused by, for example, a difference in pore size and/or a difference in density. In embodiments, the second porous structure 36 possesses a porous structure that is more “open” than the first porous structure 26. In one embodiment, the second porous structure 36 is considered to have an “open” porous structure and the first porous structure 26 is considered herein to have a “tight” porous structure. As used herein, the term “open” as opposed to “tight” means that the pore size of the “open” porous structure is larger than that of the “tight” porous structure evidenced by bubble point or any suitable means for characterizing pore size.

In embodiments, the porous support, such as the first porous support 26 and the second porous support 36, may each independently have a bubble point i.e. first and second bubble points respectively. The bubble point is a means to characterize the pore size of a porous support material and may be measured according to a bubble point measurement as further explained below. For a given fluid and pore size of a porous sheet at constant wetting, the pressure required to force an air bubble through the pore is in inverse proportion to the size of the pore (hole). The bubble point of a porous support material is not generally optimal for both, coating liquid electrolyte compositions in order to form a reinforced electrolyte layer after drying and coating liquid electrode compositions in order to form a reinforced electrode layer after drying. Consequently, the use of porous supports, e.g. porous polymer sheets conventionally used as reinforcement for a polymer composite electrolyte membrane which have a relatively tight pore structure, poorly imbibe liquid electrode compositions.

These problems with imbibing porous supports with liquid electrolyte layer compositions and liquid electrode layer compositions can be mitigated by providing a first porous support with a bubble point optimized for imbibing an electrolyte layer composition and a second porous support with a bubble point optimized for imbibing an electrode layer composition. In particular, it is preferred that the bubble point of the second porous support 36 is smaller than the bubble point of the first porous support 26. In this context, the second porous support 36 may be referred to as having an “open” pore structure, whilst the first porous support 26 may be referred to as having an “tight” pore structure.

In one embodiment the first bubble point of the first porous support may be higher than the second bubble point of the second porous support. A porous structure with a high bubble point may comprise smaller pores in contrast to a porous support with a low bubble point which may comprise larger pores.

The first bubble point of the first porous support may be 100 kPa or more, may be 200 Kpa or more, may be 300 kPa or more or may be 400 kPa or more.

The second bubble point of the second porous support may be less than 100 kPa, may be 50 kPa or less, may be 25 kPa or less, or may be 5 kPa or less.

In another embodiment, the difference between the first bubble point of the first porous support and the second bubble point of the second porous support is preferably at least 50 kPA, is at least 200 kPa, is at least 300 kPa or at least 350 kPa.

In another embodiment, the second porous support may have a second bubble point of less than 50 kPa and the first porous support may have a first bubble point of greater than 400 kPa.

In another embodiment, the first porous support may have a mass per area of less than 10 g/m², less than 5 g/m², preferably less than 2.5 g/m².

In another embodiment, the second porous support may have a mass per area of less than 3 g/m², preferably less than 1.5 g/m².

The pores of the first porous support 26 are at least partially and may be completely imbibed with first ion exchange material 25. The first porous support 26 fully imbibed with ion exchange material may be rendered occlusive. The first porous support 26 only partially imbibed with first ion exchange material may be non-occlusive or comprise non-occlusive portions.

Any non-occlusive portion of the first porous support 26 may be closest to one or both of the opposing first and second sides of the first porous support, which form the first side 22 and second side 24 of the reinforced electrolyte layer. The non-occlusive portion may be free of any of the ion exchange material. Alternatively, the non-occlusive portion may include a coating of ion exchange material to an internal surface of the first porous support 26.

Each of the first and second porous supports may have a thickness at 50% RH of at least about 1 μm, or from about 1 μm to about 50 μm, or from 1 μm to about 20 μm, or from about 2 μm to about 15 μm, or from about 3 μm to about 15 μm, or from about 3 μm to about 13 μm, or from about 3 μm to about 12 μm, or from about 3 μm to about 11 μm, or from about 3 μm to about 10 μm, or from about 3 μm to about 9 μm, or from about 4 μm to about 9 μm, or from about 4 μm to about 8 μm. The thickness of the porous supports may be measured through a SEM.

The second porous support may be un-imbibed, such that it forms an un-imbibed second porous support layer 36 into which second ion exchange material and first catalyst may be imbibed during manufacture of a MEA to provide a first reinforced electrode layer.

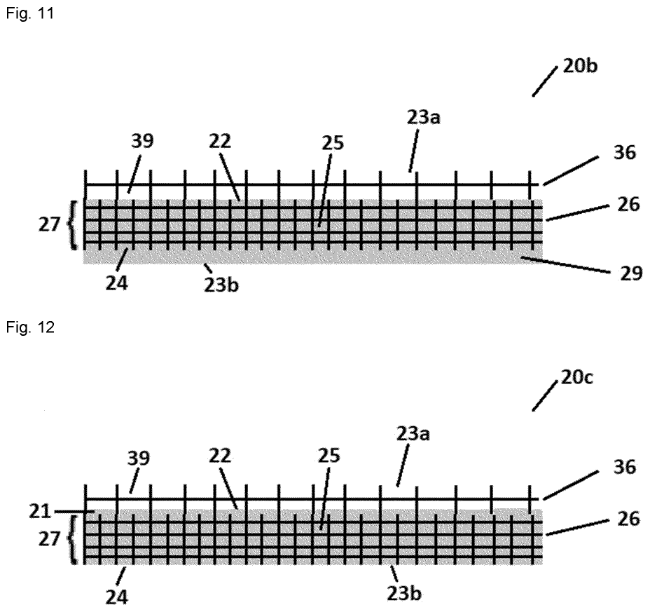

FIG. 11 shows a schematic diagram of a composite electrolyte membrane 20b according to this disclosure. In one embodiment, the composite electrolyte membrane 20b can be used to manufacture MEA 10b of FIG. 2. Composite electrolyte membrane 20b comprises a reinforced electrolyte layer 27 comprising a first porous support 26 at least partially imbibed with first ion exchange material 25 and a second porous support 36 comprising an un-imbibed region 39. The composite electrolyte membrane 20b differs from the composite electrolyte membrane 20a of FIG. 10 in that the composite electrolyte membrane 20b further comprises an unreinforced electrolyte layer 29. The first bubble point of the first porous support is greater than the second bubble point of the second porous support.

The unreinforced electrolyte layer 29 comprises an ion exchange material. The ion exchange material may be the same as or different to the first ion exchange material 25 imbibed into the first porous support 26. The second unreinforced electrolyte layer 29 may be in contact with the first porous support 26. The second unreinforced electrolyte layer 29 may lie on the opposite side of the first porous support 26 to that of the second porous support 36. Thus, one side of the second unreinforced electrolyte layer 29 may form an outer side 23b of the composite electrolyte membrane 20b, the opposite outer side 23a of the composite electrolyte membrane 20b may being provided by the outer side of the second porous support 36. The second porous support 36 is without ion exchange material.

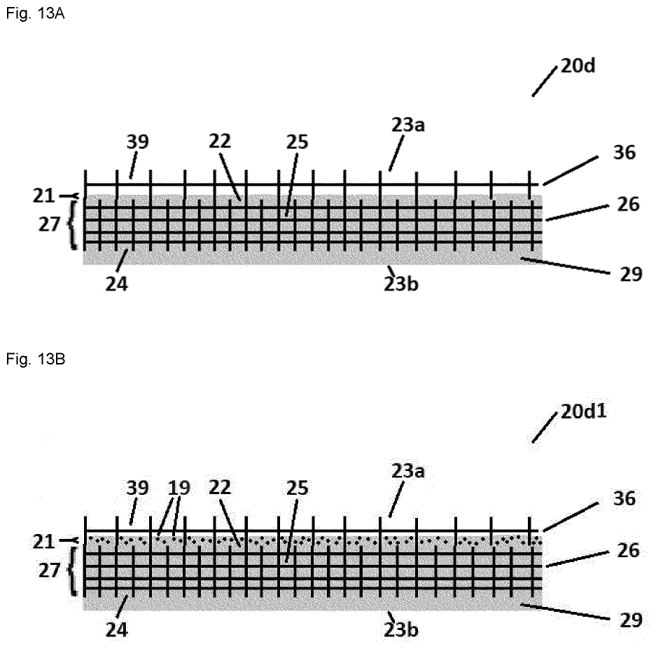

FIG. 12 shows a schematic diagram of a composite electrolyte membrane 20c according to this disclosure. In one embodiment, the composite electrolyte membrane 20c can be used in the manufacture of a MEA. Composite electrolyte membrane 20c comprises a reinforced electrolyte layer 27 comprising first porous support 26 imbibed with first ion exchange material 25 and a second porous support 36 partially imbibed with first ion exchange material. The first porous support 26 and the second porous support 36 may be in contact. The composite electrolyte membrane 20c differs from the composite electrolyte membrane 20a of FIG. 12 in that a portion of the second porous support 36 is partially imbibed with the first ion exchange material 25 of the reinforced electrolyte layer 27. The first bubble point of the first porous support is greater than the second bubble point of the second porous support.

In this embodiment, the second porous support 36 is partially impregnated with first ion exchange material 25 in the contact area of first and second porous supports. The first ion exchange material 25, which is substantially free of the first catalyst, impregnates the first porous support 26 and partially impregnates the second porous support 36.

The extension of the first ion exchange material 25 from the reinforced electrolyte layer 27 into the second porous support 36 can anchor the first porous support 26 and the second porous support 36 to provide a composite porous structure.

In this embodiment the composite electrolyte membrane 20c comprises a layer 21 of first ion exchange material 25 on top of the first side 22 of reinforced electrolyte layer 27. The layer 21 of first ion exchange material 25 is substantially free of the first catalyst. The first porous support 26 and the second porous support 36 are in contact whereby the second porous support 36 is partially imbibed with the first ion exchange material 25 of layer 21. The extension of the first ion exchange material 25 from the reinforced electrolyte layer 27 into a bottom portion of the second porous support 36 can anchor the second porous support 36. In one embodiment the first ion exchange material 25 may imbibe a bottom portion of the second porous support 36 and keep the remaining main portion of the second porous support 36 free of the first ion exchange material as un-imbibed region 39.

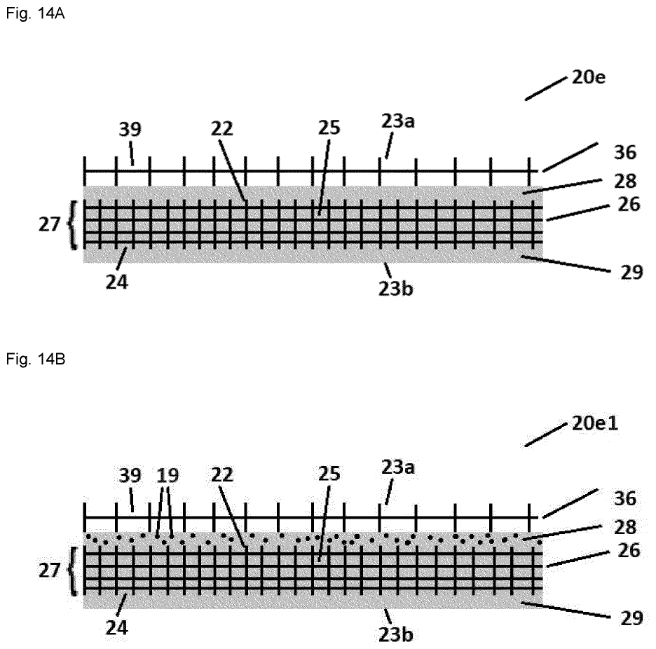

FIG. 13A shows a schematic diagram of a composite electrolyte membrane 20d which can be used in the manufacture of MEAs 10c, d of FIGS. 3 and 4A. Composite electrolyte membrane 20d comprises a reinforced electrolyte layer 27 comprising first porous support 26 imbibed with a first ion exchange material 25 and a second porous support 36 partially imbibed with first ion exchange material in layer 21. The second porous support 36 comprises an un-imbibed region 39. The first porous support 26 and the second porous support 36 may be in contact. In this embodiment a portion of the second porous support 36 is partially imbibed with the ion exchange material 25 of the reinforced electrolyte layer 27 in the contact area of the first and second porous support. The first bubble point of the first porous support is greater than the second bubble point of the second porous support.

The composite electrolyte membrane 20d differs from the composite electrolyte membrane 20c of FIG. 12 in that the composite electrolyte membrane 20d further comprises an unreinforced electrolyte layer 29. The unreinforced electrolyte layer 29 may form an outer side 23b of the composite electrolyte membrane 20d, with the opposite outer side of the second porous support 36 forming another outer side 23a of the composite electrolyte membrane. The second unreinforced electrolyte layer 29 may comprise the same ion exchange material as reinforced electrolyte layer 27 i.e. the first ion exchange material.

FIG. 13B shows a schematic diagram of a composite electrolyte membrane 20d1 which can be used in the manufacture of MEAs 10 d1 of FIG. 4B. Composite electrolyte membrane 20d1 comprises a reinforced electrolyte layer 27 comprising first porous support 26 imbibed with a first ion exchange material 25 and a second porous support 36 partially imbibed with first ion exchange material and recombination catalyst 19 in layer 21. The second porous support 36 comprises an un-imbibed region 39. The first porous support 26 and the second porous support 36 may be in contact. In this embodiment a portion of the second porous support 36 is partially imbibed with the ion exchange material 25 of the reinforced electrolyte layer 27 in the contact area of the first and second porous support. The first bubble point of the first porous support is greater than the second bubble point of the second porous support.

The composite electrolyte membrane 20d1 differs from the composite electrolyte membrane 20d of FIG. 13A in that layer 21 of the second porous support 36 is partially imbibed with recombination catalyst as well as the first ion exchange material.

FIG. 14A shows a schematic diagram of a composite electrolyte membrane 20e of this disclosure. In one embodiment, the composite electrolyte membrane 20e can be used in the manufacture of MEAs 10e, f of FIGS. 5 and 6A. The composite electrolyte membrane 20e comprises a reinforced electrolyte layer 27 comprising first porous support 26 imbibed with first ion exchange material 25 with a first unreinforced electrolyte layer 28 comprising first ion exchange material and a second unreinforced electrolyte layer 29 comprising first ion exchange material. The first unreinforced electrolyte layer 28 is in contact with the first side 22 of the reinforced electrolyte layer 27 and second unreinforced electrolyte layer 29 is in contact with the second side 24 of the reinforced electrolyte membrane 27. The composite electrolyte membrane 20e further comprises a second porous support 36 arranged on top of first unreinforced electrolyte layer 28. The second porous support 36 is without first ion exchange material, thus the second porous support 36 is an un-imbibed region 39. Such an un-imbibed region may be substantially free from ion exchange material. The first bubble point of the first porous support is greater than the second bubble point of the second porous support.

The composite electrolyte membrane 20e differs from the composite electrolyte membrane 20b of FIG. 13A in that it comprises a further unreinforced electrolyte layer 28 as a first unreinforced electrolyte layer. First unreinforced electrolyte layer 28 is located between the second porous support 36 and the reinforced electrolyte layer 27. The first and second unreinforced electrolyte layers 28, 29 may comprise the same ion exchange material as reinforced electrolyte layer 27 i.e. the first ion exchange material.

FIG. 14B shows a schematic diagram of a composite electrolyte membrane 20e1 of this disclosure. In one embodiment, the composite electrolyte membrane 20e1 can be used in the manufacture of MEAs 10f1 of FIG. 6B. The composite electrolyte membrane 20e1 comprises a reinforced electrolyte layer 27 comprising first porous support 26 imbibed with first ion exchange material 25 with a first unreinforced electrolyte layer 28 comprising first ion exchange material and recombination catalyst 19 and a second unreinforced electrolyte layer 29 comprising first ion exchange material. The first unreinforced electrolyte layer 28 is in contact with the first side 22 of the reinforced electrolyte layer 27 and second unreinforced electrolyte layer 29 is in contact with the second side 24 of the reinforced electrolyte membrane 27. The composite electrolyte membrane 20e1 further comprises a second porous support 36 arranged on top of first unreinforced electrolyte layer 28. The second porous support 36 is without first ion exchange material or recombination catalyst, thus the second porous support 36 is an un-imbibed region 39. Such an un-imbibed region may be substantially free from ion exchange material. The first bubble point of the first porous support is greater than the second bubble point of the second porous support.

The composite electrolyte membrane 20e1 differs from the composite electrolyte membrane 20e of FIG. 14A in that first unreinforced electrolyte layer 28 further comprises recombination catalyst 19.

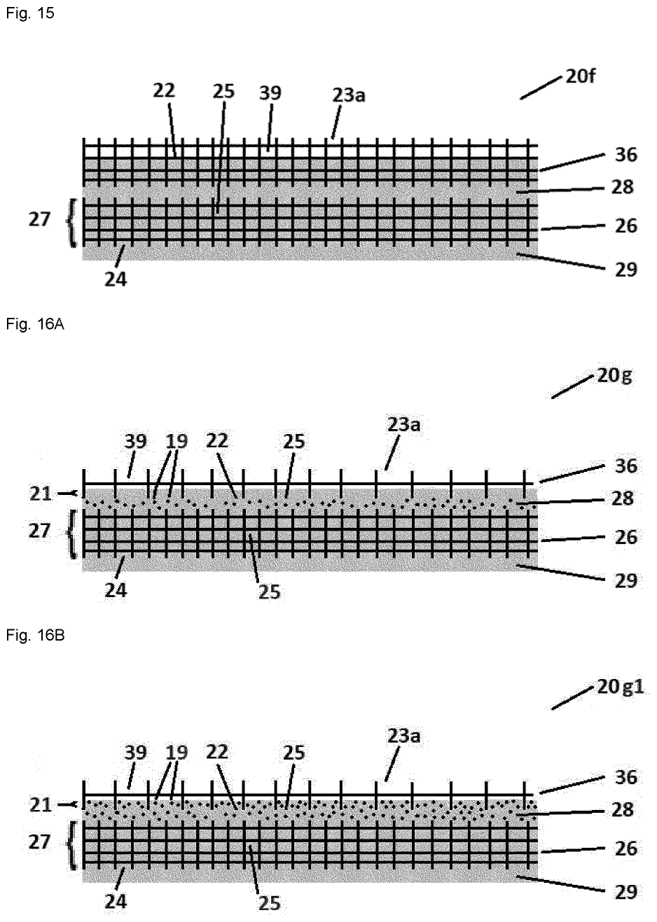

FIG. 15 shows a schematic diagram of a composite electrolyte membrane 20f which can be used in the manufacture of a MEA. The composite electrolyte membrane 20f comprises a reinforced electrolyte layer 27 comprising first porous support 26 imbibed with first ion exchange material 25, a first unreinforced electrolyte layer 28 comprising first ion exchange material and a second unreinforced electrolyte layer 29 comprising first ion exchange material. The composite electrolyte membrane 20f further comprises a second porous support 36 partially imbibed with ion exchange material of the first unreinforced electrolyte layer 28 such that a portion of the second porous support 36 is imbibed with the first ion exchange material. The second porous support 36 comprises an un-imbibed region 39. The portion of the second porous support 36 forming the outer side 23a of the composite electrolyte membrane 20f is without ion exchange material and therefore un-imbibed.

The composite electrolyte membrane 20f differs from the composite electrolyte membrane 20e of FIG. 14A in that the first porous support 26 and the second porous support 36 have the same bubble point. Preferably the first porous support 26 and the second porous support 36 are made from the same type of material, with the same properties.

FIG. 16A shows a schematic diagram of a composite electrolyte membrane 20g which can be used in the manufacture of a MEA. The composite electrolyte membrane 20g comprises a reinforced electrolyte layer 27 comprising first porous support 26 imbibed with first ion exchange material 25, a first unreinforced electrolyte layer 28 comprising first ion exchange material and a recombination catalyst 19, and a second unreinforced electrolyte layer 29 comprising first ion exchange material. The composite electrolyte membrane 20g further comprises a second porous support 36 partially imbibed with a layer 21 of first ion exchange material. The second porous support 36 comprises an un-imbibed region 39. The portion of the second porous support 36 forming the outer side 23a of the composite electrolyte membrane 20g is without ion exchange material and therefore un-imbibed. The recombination catalyst of the first unreinforced ion exchange layer 28 can be excluded from the layer 21 when the size of the recombination catalyst is larger than the pore size of the second porous support 36. The first bubble point of the first porous support is greater than the second bubble point of the second porous support.

The composite electrolyte membrane 20g differs from the composite electrolyte membrane 20e1 of FIG. 14B in that the second porous support is partially imbibed with the first ion exchange material in layer 21.

FIG. 16B shows a schematic diagram of a composite electrolyte membrane 20g1 which can be used in the manufacture of a MEA 10g of FIG. 7. The composite electrolyte membrane 20g1 comprises a reinforced electrolyte layer 27 comprising first porous support 26 imbibed with first ion exchange material 25, a first unreinforced electrolyte layer 28 comprising first ion exchange material and a recombination catalyst, and a second unreinforced electrolyte layer 29 comprising first ion exchange material. The composite electrolyte membrane 20g1 further comprises a second porous support 36 partially imbibed with a layer 21 of first ion exchange material and recombination catalyst 19. The second porous support 36 comprises an un-imbibed region 39. The portion of the second porous support 36 forming the outer side 23a of the composite electrolyte membrane 20g is without ion exchange material and therefore un-imbibed. The recombination catalyst of the first unreinforced ion exchange layer 28 can impregnate the second porous support with the first ion exchange material when the pore size of the second porous support 36 is greater than the size of the recombination catalyst. The first bubble point of the first porous support is greater than the second bubble point of the second porous support.

The composite electrolyte membrane 20g1 differs from the composite electrolyte membrane 20g of FIG. 16A in that the second porous support 36 is imbibed with the recombination catalyst 19 as well as the first ion exchange material 25 in layer 21.

FIG. 17 shows a schematic diagram of an embodiment of an asymmetric porous support 45 comprising the first porous structure 26 and second porous structure 36 as an asymmetric unitary porous structure, e.g. like an asymmetric porous membrane before the manufacture of a composite electrolyte membrane. In some embodiments, the first porous support 26 and the second porous support 36 can be provided as a unitary porous support 45. Such a unitary porous support having portions with different bubble points, corresponding to first porous support 26 and second porous support 36. For instance, this first bubble point of the first porous support is greater than the second bubble point of the second porous support. A unitary porous support can be prepared by laminating first and second porous support to each other. In various embodiments a unitary porous support may manufactured according to U.S. Pat. No. 5,225,131 or 4,478,665.

FIG. 18 shows a schematic diagram of several process steps for manufacturing a composite electrolyte membrane according to this disclosure.

The composite electrolyte membrane can be produced by the following process. In a first step I, a first electrolyte composition 25a comprising first ion exchange material and liquid carrier can be applied as a layer of controlled thickness to a releasable backing layer 50 in a single or multiple pass ionomer coating technique including forward roll coating, reverse roll coating, gravure coating, doctor coating, kiss coating, slot die coating, slide die coating, as well as dipping, brushing, painting, and spraying. The first electrolyte composition 25a may be prepared by dissolving an ion exchange material in the carrier liquid, which may be a solvent for the ion exchange material. The first electrolyte composition 25a may optionally further comprise additional components such as a surfactant. The choice of liquid carrier may depend, in part, on both the composition of the ion exchange material and the composition of the porous support to be impregnated.

The releasable backing layer 50 can be a film or fabric, such as a woven material or a non-woven material, such as a web. Suitable releasable backing layers may comprise woven materials which may include, for example, scrims made of woven fibers of expanded porous polytetrafluoroethylene; webs made of extruded or oriented polypropylene or polypropylene netting, commercially available from Conwed, Inc. of Minneapolis, Minn.; and woven materials of polypropylene and polyester, from Tetko Inc., of Briarcliff Manor, N.Y. Suitable non-woven materials for the releasable backing layer may include, for example, a spun-bonded polypropylene from Reemay Inc. of Old Hickory, Tenn. Other suitable releasable backing layers can include web of polyethylene (“PE”), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”). The releasable backing layer may also include a protective layer, which can include polyethylene (PE), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”). The releasable backing layer optionally may include a reflective layer that includes a metal substrate (e.g., an aluminum substrate). Preferably, the releasable backing layer comprises a polymer sheet substrate (obtained from DAICEL VALUE COATING LTD., Japan) comprising PET and a protective layer of cyclic olefin copolymer (COC).

In a second step II, a first porous support 26 can be laminated over at least a portion of the first electrolyte composition 25a by any conventional technique, such as, for example, hot roll lamination, ultrasonic lamination, adhesive lamination, contact lamination or forced hot air lamination so long as the technique does not damage the integrity of the microporous polymer structure of the first porous support 26.

For example, a releasable backing layer 50 can be continuously fed from a roller unwind station via alignment and tension rollers to a coating station. The first electrolyte composition 25a comprising first ion exchange material and liquid carrier can be applied as a layer of controlled thickness onto the surface of the releasable backing layer 50 by suitable coating means, such as, for example, a doctor blade. The first porous support 26 may be continuously fed from a roller unwind station to an alignment roller and contacts the coated releasable backing layer and is impregnated with first ion exchange material and liquid carrier to provide a treated first porous support 26a. Depending on the amount of first electrolyte composition 25a, the first porous support 26 may be fully impregnated with first ion exchange material while forming an unreinforced electrolyte composition layer 29a between the releasable backing layer 50 and the impregnated first porous support 26. The unreinforced electrolyte composition layer 29a is not reinforced with a porous support.

In a third step III, the treated first porous support 26a is placed into an oven to dry the first electrolyte composition 25a to remove the liquid carrier. The oven temperature may be greater than 60° C., for example from 60° to 220° C. or from 150° to 200° C. Drying the treated first porous support 26 in the oven causes the ion exchange material to become securely adhered to the internal surfaces of the first porous support, and optionally the external surfaces. The resulting dried electrolyte membrane on the releasable backing layer comprises in order an optional first unreinforced electrolyte layer 28 comprising first ion exchange material, a reinforced electrolyte layer 27 comprising first ion exchange material and an optional second unreinforced electrolyte layer 29.

In an embodiment in which a plurality of first porous supports are present, steps I-Ill may be repeated with the following modifications. In repeated step I, a first electrolyte composition comprising first ion exchange material and liquid carrier can be applied as a layer of controlled thickness to the surface of the dried electrolyte membrane of step III not covered by the releasable backing layer. In repeated step II, a (second) first porous support can be laminated over at least a portion of the first electrolyte composition applied to the surface of the dried electrolyte membrane of step III by any conventional technique to impregnate the (second) first porous support with the first electrolyte composition to provide a further treated porous support. In repeated step III, the further treated porous support can be dried to remove the liquid carrier. The resulting dried electrolyte membrane on the releasable backing layer comprises in order an optional first unreinforced electrolyte layer comprising first ion exchange material, a first reinforced electrolyte layer comprising a (first) first porous support imbibed with first ion exchange material, an optional intermediate unreinforced electrolyte layer comprising first ion exchange material, a second reinforced electrolyte layer comprising (second) first porous support imbibed with first ion exchange material and an optional second unreinforced electrolyte layer 29.

In a fourth step IV an additional layer of electrolyte composition 25b may be applied to the side of the dried electrolyte membrane opposite to the side on the releasable backing layer 50. Said additional second layer of electrolyte composition 25b may comprise first ion exchange material, liquid carrier and optionally a recombination catalyst. The first ion exchange material and liquid carrier of the second electrolyte composition 25b may be independently the same as or different to that of the first electrolyte composition in terms of concentration and/or chemical structure. The second electrolyte composition 25b may be applied to a top portion of the dried electrolyte membrane, such as a reinforced electrolyte layer 27 or first unreinforced electrolyte layer 28, via a touch roll or by the same means as the first electrolyte composition 25a to provide a layer of the second electrolyte composition.

In a fifth step V, a second porous support 36 can be applied over at least a portion of the wet layer of second electrolyte composition 25b by any conventional technique. For example, the second porous support may be continuously fed from a roller unwind station to an alignment roller and contacts the wet layer of second electrolyte composition 25b and is not impregnated or partially impregnated with first ion exchange material and liquid carrier to provide a treated composite.

When the second electrolyte composition 25b comprises a recombination catalyst and the second porous support has a pore size sufficiently large to admit the recombination catalyst, the second porous support can be partially impregnated with the recombination catalyst as well as the first ion exchange material and liquid carried to provide the treated composite.

Furthermore, when the second electrolyte composition 25b comprises a recombination catalyst, a first unreinforced electrolyte layer 28 comprising first ion exchange material and recombination catalyst can be formed from a layer of second electrolyte composition 25b between the first and second porous supports. The recombination catalyst in the second electrolyte composition 25b can be excluded from the second porous support by configuring the pore size of the second porous support to be smaller than the size of the recombination catalyst.

In embodiments, the application of the second porous support can also be done by lamination, such as, for example, hot roll lamination, ultrasonic lamination, adhesive lamination, contact lamination or forced hot air lamination so long as the technique does not damage the integrity of the second porous support. The second porous support 36 may be an un-imbibed second porous support, i.e. the second porous support is not impregnated by first ion exchange material. For example, the second porous support 36 may be continuously fed from a roller unwind station to an alignment roller and contacts first side of the reinforced electrolyte layer without impregnation of first ion exchange material and liquid carrier into the porous structure of the second porous support.

In a sixth step VI, the treated composite is placed into an oven to dry the second electrolyte composition 25b to remove the liquid carrier. The oven temperature may be greater than 60° C., for example from 60° to 220° C. or from 150° to 200° C. Drying the treated composite in the oven causes the first ion exchange material to become securely adhered to the second porous support. Any impregnated first ion exchange material and any impregnated recombination catalyst will become securely adhered to the internal surfaces of the second porous support, and optionally the external surfaces. The resulting dried composite electrolyte membrane on the releasable backing layer comprises in order an optional second unreinforced electrolyte layer 29 comprising first ion exchange material, a reinforced electrolyte layer 27 comprising first ion exchange material and an optional first unreinforced electrolyte layer 28 optionally comprising a recombination catalyst, a second porous support 36 optionally partially imbibed with first ion exchange material and optionally a recombination catalyst and comprising an un-imbibed portion forming an outer side of the composite electrolyte membrane 20. In this way, a composite electrolyte membrane 20a, b, c, e, f, g as shown in FIGS. 10 to 16B may be provided.

When a first unreinforced electrolyte layer 28 is present as the surface layer of the dried reinforced electrolyte layer 27, the second porous support 36 may be in contact with the first unreinforced electrolyte layer 28 optionally comprising a recombination catalyst, and the composite electrolyte membranes 20e, f and g of FIGS. 14A, 14B, 15, 16A and 16B may be provided.

Alternatively, if there is no first unreinforced electrolyte layer, the second porous support 36 may be in contact with first porous support 26 of the reinforced electrolyte layer 27, and the composite electrolyte membranes 20a, b, c, d of FIGS. 10 to 13B may be provided.

In an alternative embodiment, such as for the manufacture of composite electrolyte membranes 20a, b, c, d according to FIGS. 10 to 13B, the first porous support and second porous support can be provided as a unitary structure. The bubble point of the second porous support is less than the bubble point of the first porous support. Consequently, laminating step two also introduces the second porous support. Thus, the fourth and fifth steps in the process of manufacture of the composite electrolyte membrane described above can be omitted when the first porous support is fully occluded by the ion exchange material from the first ion exchange material composition.

### Electrode Catalyst

There is no particular restriction on the catalyst in the first and second electrode, such as the first catalyst and second catalyst, and any known catalyst can be used, such as those typically used for an anode or a cathode of a fuel cell or an electrolyzer. The nature of the catalyst may vary widely. The first catalyst and second catalyst may be the same or may be different. The catalyst may comprise noble metals, transition metals, or alloys thereof. The catalyst may comprise one or more of Pt, Ir, Ni, Co, Pd, Ti, Sn, Ta, Nb, Sb, Pb, Mn, Ru and Fe, their oxides, and mixtures thereof. More specific examples of catalytic materials include platinum, ruthenium, iridium, cobalt, and palladium, and are not limited to elemental metals. For example, the catalyst may also comprise iridium oxide, a platinum-ruthenium alloy, a platinum-iridium alloy, a platinum-cobalt alloy, etc. In some embodiments, the catalyst comprises a core shell catalyst, as described, for example, in US Patent Appn. Pubn. No. 2016/0126560, the entirety of which is incorporated herein by reference. In some embodiments, the catalyst may comprise a catalyst support, such that it is a supported catalyst. Such supported catalysts may comprise carbon as the support material, preferably carbon black. For example, in some embodiments, the catalyst comprises a supported platinum catalyst, such as platinum on carbon black.

The catalyst loading in the first or any second electrode may be in the range of from 0.05 to 0.45 mg/cm². Preferably the catalyst loading is in the range of from 0.1 to 0.3 mg/cm²

### Recombination Catalyst

The recombination catalyst may be a catalyst capable of catalysing the reaction between molecular hydrogen and molecular oxygen to produce water. The recombination catalyst may comprise a single recombination catalyst species or a mixture of recombination catalyst species. The recombination catalyst may comprise one or more catalytic species selected from: Pt, Ir, Ni, Co, Pd, Ti, Sn, Ta, Nb, Sb, Pb, Mn, and Ru, their oxides, and mixtures thereof. The recombination catalyst may comprise a platinum group metal (Group 10 metal) such as platinum, palladium, iridium, rhodium, ruthenium or osmium; alloys of platinum group metals; and mixed oxides of platinum group metals with other metals such as cerium and titanium, and mixtures thereof; or wherein the recombination catalyst comprises one or more of Pt, Ir, Ni, Co, Pd, Ti, Sn, Ta, Nb, Sb, Pb, Mn, and Ru, their oxides and mixtures thereof. The recombination catalyst may comprise a single recombination catalyst species or a mixture of recombination catalyst species. The recombination catalyst may be mixed with first ion exchange material. The recombination catalyst may be dispersed throughout the layer of first ion exchange material.

The recombination catalyst may be present on a recombination catalyst support material. The support material may comprise silica; zeolites; carbon; and oxides and carbides of the group IVB, VB, VIB VIIB, and VIII transition metals; and combinations thereof. Carbon is a particularly preferable support material. They preferably have high surface area, and so should be small in size, less than 75 nm, or preferably less than 50 nm, or less than 25 nm. They may also optionally be porous. The use of high surface area supports is particularly advantageous because it allows the recombination catalyst to be highly dispersed, leading to higher catalytic activity per unit weight compared with an unsupported, lower surface area catalysts of the same composition.

The recombination catalyst may be present at a loading of less than 0.1 mg/cm² in the composite electrolyte membrane. The recombination catalyst may be present at a loading in the range of from about 0.0001 mg/cm² to about 0.1 mg/cm², or from about 0.0005 mg/cm² to about 0.1 mg/cm², or from about 0.0008 mg/cm² to about 0.1 mg/cm², or from about 0.001 mg/cm² to about 0.1 mg/cm², or from about 0.0015 mg/cm² to about 0.1 mg/cm², or from about 0.002 mg/cm² to about 0.1 mg/cm², or from about 0.0025 mg/cm² to about 0.1 mg/cm², or from about 0.003 mg/cm² to about 0.1 mg/cm², or from about 0.0043 mg/cm² to about 0.0.005 mg/cm², or from about 0.0035 mg/cm² to about 0.1 mg/cm², or from about 0.005 mg/cm² to about 0.1 mg/cm², or from about 0.007 mg/cm² to about 0.1 mg/cm², or from about 0.009 mg/cm² to about 0.1 mg/cm², or from about 0.01 mg/cm² to about 0.1 mg/cm², or from about 0.04 mg/cm² to about 0.1 mg/cm², or from about 0.085 mg/cm² to about 0.1 mg/cm², or from about 0.013 mg/cm² to about 0.015 mg/cm², or from about 0.0001 mg/cm² to about 0.001 mg/cm², or from about 0.0001 mg/cm² to about 0.005 mg/cm², or from about 0.0001 mg/cm² to about 0.008 mg/cm², or from about 0.0001 mg/cm² to about 0.01 mg/cm², or from about 0.0001 mg/cm² to about 0.05 mg/cm², or from about 0.001 mg/cm² to about 0.01 mg/cm², or from about 0.004 mg/cm² to about 0.01 mg/cm², in the composite electrolyte membrane.

The recombination catalyst may be present in at least one layer of ion exchange material, for example a layer of first or second ion exchange material, at a loading of up to about 0.10 mg/cm², or at a loading in the range of from about 0.001 mg/cm² to about 0.09 mg/cm², or at a loading in the range of from about 0.006 mg/cm² to about 0.02 mg/cm².

### Additive

The additive can decompose hydrogen peroxide and/or eliminate the peroxide radicals. The additive may be a peroxide decomposition catalyst, a radical scavenger, a free radical decomposition catalyst, a self-regenerating antioxidant, a hydrogen donor primary antioxidant, a free radical scavenger secondary antioxidant, an oxygen absorbent, and the like. The additive may comprise Ce, Mn or their oxides. For example, the additive may be a cerium dioxide (ceria). For the avoidance of doubt, the additive may be added in addition to the recombination catalyst. The additive may be present in combination with the first ion exchange material, for instance the first layer of first ion exchange material may further comprise such an additive, and/or the second layer of first ion exchange material may further comprise such an additive, and/or such an additive may be imbibed into at least a portion of the first porous support with the first ion exchange material, and/or such an additive may be imbibed into a portion of the second porous support with the first ion exchange material.

The additive may be present in at least one layer of ion exchange material, for example first or second ion exchange material, at a loading of from about 10 mg/cm², or at a loading in the range of from about 10 mg/cm² to about 500 mg/cm².

### Ion Exchange Material

A suitable ion exchange material for the composite electrolyte membrane, first electrode and second electrode, such as the first and second ion exchange materials, may be dependent on the application in which the membrane electrode assembly is to be used. The ion exchange material may be chemically and thermally stable in the environment in which the membrane electrode assembly is to be used. The ion exchange material for the composite electrolyte membrane, first electrode and any second electrode may be selected independently.

A suitable ion exchange material for fuel cell applications may include a cation exchange material, an anion exchange material, or an ion exchange material containing both cation and anion exchange capabilities. Mixtures of ion exchange materials may also be employed.

The ion exchange material may comprise at least one ionomer. The at least one ionomer may have a density not lower than about 1.9 g/cc at 0% relative humidity. The at least one ionomer may comprise a proton conducting polymer or cation exchange material.

The ion exchange material may be selected from the group comprising perfluorocarboxylic acid polymers, perfluorophosphonic acid polymers, styrenic ion exchange polymers, fluorostyrenic ion exchange polymers, polyarylether ketone ion exchange polymers, polysulfone ion exchange polymers, bis(fluoroalkylsulfonyl)imides, (fluoroalkylsulfonyl) (fluorosulfonyl) imides, polyvinyl alcohol, polyethylene oxides, divinyl benzene, metal salts with or without a polymer and mixtures thereof. Examples of suitable perfluorosulfonic acid polymers for use in fuel cell applications include Nafion® (E.I. DuPont de Nemours, Inc., Wilmington, Del., US), Flemion® (Asahi Glass Co. Ltd., Tokyo, JP), Aciplex® (Asahi Chemical Co. Ltd., Tokyo, JP), Aquivion® (SolvaySolexis S.P.A, Italy), and 3M™ (3M Innovative Properties Company, USA) which are commercially available perfluorosulfonic acid copolymers. Other examples of suitable perfluorosulfonic acid polymers for use in fuel cell applications include perfluorinated sulfonyl (co)polymers such as those described in U.S. Pat. No. 5,463,005. The proton conducting polymer preferably comprises perfluorosulfonic acid.

In embodiments, the composite electrolyte membrane comprises a first ion exchange material and the first and second electrode comprises second and third ion exchange materials respectively.

The ion exchange material of the first electrode, second electrode and composite electrolyte membrane, such as the first, second and third ion exchange materials, may independently be the same or different in terms of one or more of the chemical nature of the ion exchange material, its equivalent weight etc.

The first ion exchange material preferably has a low equivalent weight (EW) and is chemically and thermally stable in the environment in which the composite electrolyte membrane is to be used. Preferably the first ion exchange material comprises perfluorosulfonic acid. Preferably the second and third ion exchange materials comprise perfluorosulfonic acid.

### Porous Support

The composite electrolyte membrane and first electrode comprise each a porous support which is at least partially imbibed with first ion exchange material or second ion exchange material and first catalyst respectively.

In one embodiment the first porous structure and the second porous structure are independent layers. In an alternative embodiment the first and second porous structures are unitary provided as an asymmetric porous structure, e.g. an asymmetric porous membrane.

The difference between the first porous structure and the second porous structure may be caused by, for example, a difference in pore size and/or a difference in density. In embodiments, the second porous structure possesses a porous structure that is more “open” than the first porous structure. In one embodiment, the second porous structure is considered to have an “open” porous structure and the first porous structure is considered herein to have a “tight” porous structure. As used herein, the term “open” as opposed to “tight” can mean that the pore size of the “open” porous structure is larger than that of the “tight” porous structure evidenced by bubble point or any other suitable means for characterizing pore size.

In embodiments, the porous support, such as the first porous support and the second porous support, may each independently have a bubble point. The bubble point is a means to characterize the pore size of a porous support and may be measured according to a bubble point measurement as further explained below. For a given fluid and pore size of a porous sheet at constant wetting, the pressure required to force an air bubble through the pore is in inverse proportion to the size of the pore (hole). The bubble point of a porous support is not generally optimal for both, coating liquid electrolyte compositions in order to form a reinforced electrolyte layer after drying and coating liquid electrode compositions in order to form a reinforced electrode layer after drying. Consequently, the use of porous supports, e.g. porous polymer sheets conventionally used as reinforcement for a polymer composite electrolyte membrane have a relatively tight pore structure which poorly imbibe liquid electrode compositions.

These problems with imbibing porous supports with liquid electrolyte layer compositions and liquid electrode layer compositions can be mitigated by providing a first porous support with a bubble point optimized for imbibing an electrolyte layer composition and a second porous support with a bubble point optimized for imbibing an electrode layer composition. In particular, it is preferred that the bubble point of the second porous support is smaller than the bubble point of the first porous support. In this context, the second porous support may be referred to as having an “open” pore structure, whilst the first porous support may be referred to as having an “tight” pore structure.

In one embodiment the bubble point of the first porous support may be higher than the bubble point of the second porous support. A porous structure with a high bubble point may comprise smaller pores in contrast to a porous support with a low bubble point which may comprise larger pores.

This allows the second porous support to be optimized for impregnation by an electrode composition comprising liquid carrier, second ion exchange material and catalyst, and the first porous support to be optimized for impregnation by an electrolyte composition comprising liquid carrier and ion exchange material.

The bubble point of the first porous support may be 100 kPa or more, may be 200 KPa or more, may be 300 kPa or more, may be 400 kPa or more or may be 500 kPa or more.

The bubble point of the second porous support may be less than 100 kPa, may be 50 kPa or less, may be 25 kPa or less, or may be 5 kPa or less.

In another embodiment, the difference between the bubble point of the first porous support and the second porous support is preferably at least 50 kPA, is at least 200 kPa, is at least 300 kPa or at least 350 kPa.

In another embodiment, the second porous support may have a bubble point of less than 50 kPa and the first porous support may have a bubble point of greater than 400 kPa.

In another embodiment, the first porous support may have a mass per area of less than 10 g/m², preferably less than 5 g/m², preferable less than 2.5 g/m².

In another embodiment, the second porous support may have a mass per area of less than 3 g/m², preferably less than 1.5 g/m².

The first and second porous support and its various embodiments and properties are further described in relation to FIGS. 10 to 17.

The porous support, such as the first porous support and second porous support, may be a porous polymer structure.

The porous polymer structure may comprise at least one fluorinated polymer e.g. a polymeric fluorocarbon material or at least one hydrocarbon polymer e.g. a polymeric hydrocarbon material. In one embodiment the at least one fluorinated polymer may be a perfluorinated porous polymeric material. In one embodiment the at least one fluorinated polymer may be selected from the group comprising polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) and mixtures thereof. The at least one fluorinated polymer is preferably an expanded polytetrafluoroethylene (ePTFE) membrane.

In another embodiment, the porous polymer structure may comprise a hydrocarbon polymer. The hydrocarbon polymer may be selected from the group comprising polyethylene, polypropylene, polycarbonate, polystyrene, polysulfone, polyethersulfone, polyethylene naphthalate and mixture and mixtures thereof.

Examples of suitable perfluorinated porous polymeric materials include ePTFE made in accordance with the teachings of U.S. Pat. No. 8,757,395, which is incorporated herein by reference in its entirety, and commercially available in a variety of forms from W. L. Gore & Associates, Inc., of Elkton, Md.

The porous support, such as the first porous support, and second porous support, may have a first surface and an opposing second surface.

In embodiment, in the first porous support, the first ion exchange material may form a layer on the first surface, on the second surface, or both on the first surface and the second surface. Such a layer is an unreinforced electrolyte layer, which is free from the first porous support. The first ion exchange material may be partially embedded within the first porous support leaving a non-occlusive portion of the first porous support closest to the first surface, second surface or both. The non-occlusive portion may be free of any of the first ion exchange material. The non-occlusive portion may include a coating of ion exchange material to an internal surface of the first porous support. The first ion exchange material may be fully embedded within the first porous support rendering the first porous support fully occlusive. The first ion exchange material embedded within the first porous support forms a reinforced electrolyte layer comprising the first porous support at least partially imbibed with ion exchange material.

The composite electrolyte membrane may comprise a single first porous support. The composite electrolyte membrane may comprise more than one first porous supports. When the composite electrolyte membrane comprises at least two first porous supports, the composition of each first porous support may be the same, or it may be different.

In embodiments, in the second porous support, the second ion exchange material and catalyst may form a layer on one of the first and second sides of the second porous support. Such a layer is an unreinforced electrode layer, which is free from the second porous support. In an MEA such a layer is located on the side of the second porous support which is opposite to that side which is in contact with the composite electrolyte membrane. The second ion exchange material and first catalyst are partially embedded within the second porous support and may leave a non-occlusive portion of the second porous support closest to the first surface, second surface or both. The non-occlusive portion may be free of any of the ion exchange material. The non-occlusive portion may include a coating of second ion exchange material and first catalyst, to an internal surface of the second porous support. The second ion exchange material and first catalyst embedded within the second porous support forms a reinforced electrode layer comprising the second porous support at least partially imbibed with second ion exchange material and first catalyst.

The first electrode may comprise a single second porous support. The first electrode may comprise more than one second porous supports. When the first electrode comprises at least two second porous supports, the composition of each second porous support may be the same, or it may be different.

### Process for the Manufacture of a Membrane Electrode Assembly

Membrane electrode assemblies (MEA) such as those previously described can be produced by forming an electrode directly on a composite electrolyte membrane.

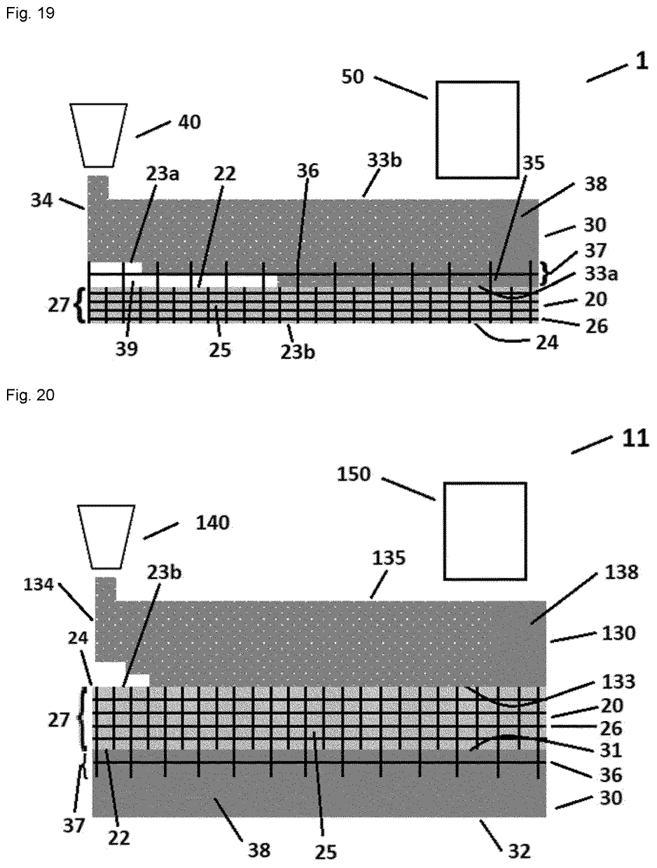

The disclosed processes for the manufacture of an MEA include steps as described below and illustrated in the FIGS. 19, 20 and 21. Although described as sequential steps for the purposes of explanation, this disclosure contemplates that in practice the steps may be performed in any order or simultaneously unless stated otherwise.

An MEA may be produced continuously or discontinuously as described herein. An MEA may be continuously produced, for instance using a roll feed and/or roll winder, deposition apparatus, and a heating apparatus. The roll feed and/or roll winder may be rollers or alternative means of web conveyance. The deposition apparatus may be a slot die or alternative means of film coating. The heating apparatus may be a convection oven or alternative means of wet film drying.

Alternatively, the MEA may be produced in a discontinuous manner, with the various process steps carried out separately, with optional storage of any intermediate between the process steps. For instance, the first and second electrodes may be applied in separate process lines, with optional intermediate storage of the membrane electrode assembly comprising the first electrode and the composite electrolyte membrane, prior to application of any second electrode.

FIG. 19 shows a schematic process 1 for the application of a first electrode composition to a second porous support 36 of a composite electrolyte membrane 20, in particular to an un-imbibed region of the second porous support 36 forming a first surface 23a of the composite electrolyte membrane 20. The first electrode composition comprises a first catalyst, second ion exchange material and liquid carrier. The first electrode composition is a liquid composition.

The composite electrolyte membrane 20 comprises a reinforced electrolyte layer 27 comprising a first porous support 26 at least partially imbibed with a first ion exchange material 25. The composite electrolyte membrane further comprises a second porous support 36 comprising an un-imbibed region 39 which is free of the first ion exchange material. The composite electrolyte membrane 20 comprises a first side 23a and a second side 23b. The first side of the composite electrolyte membrane may be defined by the un-imbibed region 39 of the second porous support 36. The second side 23b of the composite electrolyte membrane may be formed by in one embodiment by the second side of the reinforced electrolyte membrane 24 or in another embodiment by the first unreinforced electrolyte layer 29 (not shown in FIG. 19).

The composite electrolyte membrane 20 may optionally be provided on a releasable backing layer (shown in FIG. 21) as defined previously. A first electrode composition 34 can be applied to the first side 23a of the composite electrolyte membrane 20 which corresponds to the un-imbibed region 39 of the second porous support 36 via a first electrode composition deposition apparatus 40. The composite electrolyte membrane 20 may be positioned on roll feed and/or roll winder. The composite electrolyte membrane 20 may be on a releasable backing layer as discussed above, in which case the releasable backing layer is in contact with the roll feed and/or roll winder such that the releasable backing layer lies between the composite electrolyte membrane and the roll feed and/or roll winder. The composite electrolyte membrane 20 according to this disclosure is placed such that the un-imbibed region 39 of the second porous 36 is facing the deposition apparatus 40. The application of the first electrode composition to the surface of the second porous support 36 provides a wet layer 34 of the first electrode composition on the second porous support 36 and allows the first electrode composition to penetrate the pores of the second porous support so that the second porous support is at least partially imbibed with the second ion exchange material, first catalyst and liquid carrier of the first electrode composition.

The term “applying” is intended to include but not be limited to various means of applying liquid compositions, such as slot die coating, slide die coating, curtain coating, gravure coating, reverse roll coating, spray coating, knife-over-roll coating, and dip coating. The first electrode composition deposition apparatus 40 may therefore be a slot die coating apparatus, a slide die coating apparatus, a curtain coating apparatus, a gravure coating apparatus, a reverse roll coating apparatus, a spray coating apparatus, a knife-over-roll coating apparatus, or a dip coating apparatus. A slot die coating apparatus is preferred. One preferred application of the first electrode composition and/or a second electrode composition is a direct coating process.

In the embodiment of FIG. 19 the first electrode composition, once imbibed into the second porous support 36, may provide a wet layer of a first electrode composition 34 imbibed second porous support 36 comprising the second porous support and the first electrode composition. The wet layer 34 has a first side 33a and an opposing second side 33b, with the first side 33a in contact with the first side 22 of the reinforced electrolyte layer 27 of the composite electrolyte membrane 20.

A first multi-layer assembly is provided, comprising in order, an optional releasable backing layer, composite electrolyte membrane 20 and wet layer 34 of a first electrode composition imbibed second porous support, whereby the second porous support 36 of the composite electrolyte membrane 20 becomes part of the wet layer 34. In the embodiment shown in FIG. 19, the first electrode composition 34 is imbibed into the second porous support 36, with excess first electrode composition lying in an unreinforced layer on the surface of the of the first electrode composition imbibed second porous support.

The first multi-layer assembly may then be heated to remove liquid carrier from the wet layer 34. In this way, the wet layer 34 may be substantially dried to form a reinforced electrode layer 37 of a first electrode 30.

For instance, the first multi-layered assembly may be conveyed to any suitable first heating device 50, such as an oven, drier or IR lamp, via the roll feed and/or roll winder. The heating may be carried out at a temperature greater than 60° C., greater than 75° C., greater than 100° C., greater than 130° C., from 60° C. to 160° C., or from 100° C. to 150° C., optionally at a drying time from 0.01 to 10 minutes, e.g., from 0.1 to 8 minutes, from 0.1 to 5 minutes, from 0.1 to 2 minutes, or from 0.1 to 1 minute. The drying of the wet layer 34 forms a dry first electrode 30 on the composite electrolyte membrane 20.

During drying, the liquid carrier evaporates from the uncovered second side 33b of the wet layer 34 to provide a reinforced electrode layer 37 comprising second porous support 36 at least partially imbibed with second ion exchange material 35. Cracking of the uncovered side 33b of the wet layer is mitigated upon drying by the structural support provided by the second porous support 36.

The heating step therefore provides a membrane electrode assembly, comprising in order, an optional releasable backing layer, a composite electrolyte membrane 20 and a first electrode 30.

In the process of FIG. 19, a sufficient amount of first electrode composition is applied to the second porous support to fully imbibe the second porous support with first electrode composition with the excess forming a layer of first electrode composition on the surface of the fully imbibed second porous support. This provides an unreinforced electrode layer 38 on the surface of the reinforced electrode layer 37 upon drying. Such a configuration could also be provided in an alternative embodiment not shown in FIG. 19 by more than one application of the first electrode composition to the second porous support, optionally with a drying step after each application, in order to deposit multiple passes of first electrode composition to provide a reinforced electrode layer and an unreinforced electrode layer.

In an alternative embodiment, not shown in FIG. 19, the amount of first electrode composition applied to the second porous support can be adjusted in order to only partially imbibe the second porous layer so that the upper surface of the second porous layer is non-occluded upon drying.

In a further alternative embodiment, not shown in FIG. 19, the amount of first electrode composition applied to the second porous support can be adjusted in order to fully imbibe the second porous layer but without an excess on the surface of the second porous support so that a reinforced electrode layer is provided, which may comprise the second porous layer fully imbibed with first catalyst and second ion exchange material to form a fully occluded layer, but without an unreinforced electrode layer on the surface of the second porous support.

FIG. 19 illustrates the formation of the first electrode in a process for the manufacture of a MEA corresponding to that of FIG. 1 (with the addition of an unreinforced electrode layer) from the composite electrolyte membrane 20a shown in FIG. 10. It will be apparent that this process can be applied to any of the composite electrolyte membranes shown in FIGS. 10 to 16B in order to provide a first electrode comprising a reinforced electrode layer on the composite electrolyte membrane.

In an optional step not shown in FIG. 19, a releasable support may be applied to the first electrode 30 after the heating step. The first electrode 30 may comprise a first side and an opposing second side. The first side of the first electrode 30 is in contact with the first side 22 of the reinforced electrolyte layer 27 in the MEA. The releasable support may be applied to the second side of the first electrode 30 after heating the wet layer 34 to remove liquid carrier, but before the application of any second electrode composition to the second side 24 of the reinforced electrolyte layer 27 as discussed below.

The releasable support protects the second side of the first electrode 30 and provides support and stability to the MEA for subsequent processing steps. The releasable support may comprise a single layer or film, which can be formed of a plastics material. The releasable support can be a film or fabric, such as a woven material, or a non-woven material, such as a web.

The releasable support may have a thickness of lower than 250 micrometers, lower than 200 micrometers, lower than 150 micrometers, lower than 100 micrometers, lower than 50 micrometers.

The releasable support can be applied to the second side of the first electrode 30 by a hot roll lamination process. The lamination process may comprise a heated roll pressing step. The heated roll may have a temperature of about 160° C. The lamination pressure may be between 0.35 MPa/m and 0.50 MPa/m, preferably at about 0.48 MPa/m or at about 0.42 MPa/m.

In the process 1 of FIG. 19, the second porous support 36 may be a unitary structure with the first porous support 26, so long as the bubble point of the portion of the unitary structure forming the second porous support 36 is less than the bubble point of the portion of the unitary structure forming the first porous support 26.

The processes described herein may further provide a second electrode on the opposite side of the composite electrolyte membrane to the first electrode.

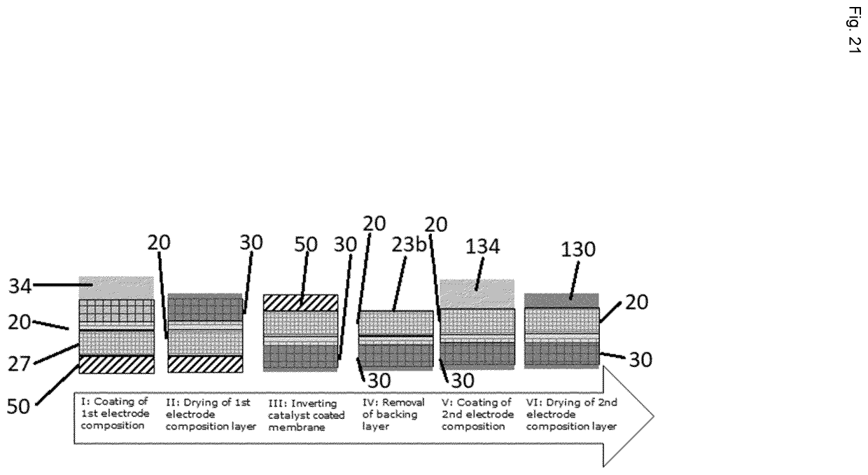

FIG. 20 shows a schematic process 11 for the application of a second electrode composition 134 to a second side 23b of the composite electrolyte membrane 20. The second electrode composition 134 comprises a second catalyst, third ion exchange material and a liquid carrier. The second electrode composition is a liquid composition

The first side 22 of the reinforced electrolyte layer 27 of the composite electrolyte membrane 20 is in contact with the first electrode 30 produced as previously described. If the composite electrolyte membrane 20 is provided with a releasable backing layer in contact with the second side of the composite electrolyte 20 membrane, the releasable backing layer can be separated to uncover the second side of the composite electrolyte membrane 20.

The composite electrolyte membrane 20 can be positioned with the first electrode 30 in contact with a roll feed and/or roll winder with the second side of the composite electrolyte membrane 20, for example the second side 24 of the reinforced electrolyte layer 27, uppermost and uncovered. If an optional releasable support (not shown) is present on the second side of the first electrode 30, the releasable support can be in contact with the roll feed and/or roll winder, between the first electrode 30 and roll feed and/or roll winder.

In a continuous process, the membrane electrode assembly comprising the first electrode 30 on the composite electrolyte membrane 20 may be flipped or inverted from the production of the first electrode 30 such that the second side of the composite electrolyte membrane 20 is on top of the first electrode 30.

The MEA comprising the optional releasable support, first electrode 30 and composite electrolyte membrane 20 can then be conveyed to a second electrode composition deposition apparatus 140, for instance via the roll feed and/or roll winder.

A second electrode composition 134 can be applied to the surface of the second side of the composite electrolyte membrane 20 via the second electrode composition deposition apparatus 140. The second electrode composition 134 comprises a second catalyst, an third ion exchange material and a liquid carrier. The first and second catalysts may be the same or different. In some embodiments, the catalyst loading in the first electrode composition and second electrode composition may be substantially the same after removal of the liquid carrier. The second and third ion exchange materials may be the same or different.

The application of the second electrode composition 134 to the surface of the composite electrolyte membrane 20 provides a layer of the second electrode composition 134 on the second side 23b of the composite electrolyte membrane 20.

The applying can be carried out by one of the means disclosed for applying the first electrode composition, such that the second electrode composition deposition apparatus 140 may be independently selected from those discussed for the first electrode deposition apparatus 40.

The second electrode composition, once applied to the composite electrolyte membrane 20, may provide a wet layer 134 comprising the second electrode composition. The wet layer 134 has a first side 133 and an opposing second side 135, with the first side 133 in contact with the second side 23b of the composite electrolyte membrane 20.

A second multi-layer assembly is provided, comprising in order, an optional releasable support, first electrode 30, composite electrolyte membrane 20 and wet layer 134. In the embodiment shown in FIG. 20, the second electrode composition 134 is on the second surface 24 of the reinforced electrolyte layer 27 at least partially imbibed with ion exchange material.

The second multi-layer assembly may then be heated to remove liquid carrier from the wet layer 134. In this way, the wet layer 134 may be substantially dried to form a second electrode 130 comprising second catalyst and third ion exchange material.

For instance, the second multi-layered assembly may be conveyed to any suitable second heating device 150, such as an oven, drier or IR lamp, via the roll feed and/or roll winder. The heating may be carried out at temperatures and durations independently selected from those described above for the wet layer 34 forming the first electrode 30. The drying of the wet layer of second electrode composition 134 forms a dry second electrode 130 on the composite electrolyte membrane 20. During drying, the liquid carrier evaporates from the uncovered second side 135 of the wet layer 134.

The second heating step therefore provides a membrane electrode assembly, comprising in order, an optional releasable support, a first electrode 30, a composite electrolyte membrane 20 and a second electrode 130.

FIG. 20 illustrates a process to complete the manufacture of a MEA corresponding to that of FIG. 1 (with the addition of an unreinforced first electrode layer) from the composite electrode 20a shown in FIG. 10. It will be apparent that this process can also be applied to any of the composite electrolyte membranes shown in FIGS. 11-16B to manufacture MEAs according to FIGS. 2-9.

FIG. 21 shows a schematic process diagram of the process steps explained in the embodiments of FIG. 19 and FIG. 20. Starting on the left side of the diagram, step I represents the first multi-layer assembly with a releasable backing layer 50, composite electrolyte membrane 20 and wet layer of a first electrode composition 34 imbibed second porous support. In step II the first multilayer assembly may then be heated to remove liquid carrier from the wet layer 34 to form the first electrode 30. The first electrode may comprise a reinforced electrode layer comprising second porous support at least partially imbibed with first catalyst and second ion exchange material and optionally an unreinforced first electrode layer comprising first catalyst and second ion exchange material. In step III the catalyst coated MEA (CCM) of step II has been inverted such that the second side of the composite electrolyte membrane is on top of the first side, with the releasable backing layer 50 uppermost. In step IV the releasable backing layer 50 has been removed to uncover the second side 23b of the composite electrolyte membrane 20. Step V shows a second multi-layer assembly after the application of the second electrode composition to the second side of the composite electrolyte membrane 20. The second multi-layer assembly comprises in order the first electrode 30, composite electrolyte membrane 20 and wet layer 134 of second electrode composition. After another heating step VI, to remove liquid carrier from the second electrode composition 134, a MEA is provided comprising first electrode 30, composite electrolyte membrane 20 and second electrode 130.

In a further step not shown in the embodiments of FIGS. 19 to 21, a first gas diffusion layer (GDL) may be provided on the membrane electrode assembly. The first GDL may have a first side and an opposing second side. The first side of the first GDL may be applied to the second side of the first electrode to provide a membrane electrode assembly comprising, in order, the first gas diffusion layer, the first electrode, the composite electrolyte and second electrode. The first gas diffusion layer may be applied to the second side of the first electrode by any conventional technique, such as lamination. For instance, the first GDL can be laminated to the first electrode under pressure and with heating. The first gas diffusion layer may comprise a porous carbon particle layer, such as microporous carbon paper.

If the membrane electrode assembly is provided with a releasable support on the second side of the first electrode, the process further comprises the step of separating the releasable support from the first electrode before the first gas diffusion layer is applied to the second side of the first electrode.

In a further step not shown in the embodiments of FIGS. 19 to 21, a second gas diffusion layer may be provided on the membrane electrode assembly. The second GDL may have a first side and an opposing second side. The first side of the second GDL may be applied to the second side of the second electrode to provide a membrane electrode assembly comprising, in order, the first gas diffusion layer, the first electrode, the composite electrolyte membrane, the second electrode and the second gas diffusion layer 160. The second gas diffusion layer may comprise a porous carbon particle layer, such as microporous carbon paper.

### Electrode and Electrolyte Compositions

The first and second electrode composition comprises a second or third ion exchange material, a first or second catalyst and a liquid carrier. The electrolyte composition comprises a first ion exchange material and a liquid carrier.

The first or second catalyst in the first or second electrode compositions may be independently selected from those described above. The first or second catalyst may be present in the first or second electrode composition in an amount less than about 90 wt. %, less than about 35 wt. %, or less than about 9 wt. %, based on a total weight of the electrode first or second electrode composition. For example, the first or second catalyst may be present in the first or second electrode composition in an amount from 1 wt. % to 90 wt. %, from 1 wt. % to 42 wt. %, or from 3 wt. % to 30 wt. %, based on a total weight of the first or second electrode composition.

A suitable ion exchange material for the first or second electrode composition or electrolyte composition, i.e. the first, second or third ion exchange materials, may be independently selected from those described above. The ion exchange material may be independently present in the first or second electrode composition or electrolyte composition in an amount less than about 50 wt. %, less than about 35 wt. %, less than about 8 wt. %, or less than about 0.5 wt. %, based on a total weight of the ion exchange material and liquid carrier in the composition, such as the first or second electrode composition or electrolyte composition. For example, the ion exchange material may be independently present in the first or second electrode composition or electrolyte composition in an amount from 0.5 wt. % to 50 wt. %, based on a total weight of the ion exchange material and liquid carrier in the composition.

A suitable recombination catalyst for the first or second electrolyte compositions, may be independently selected from those described above. The recombination catalyst may be independently present in the first or second electrolyte composition in an amount less than about 8 wt. % or less than about 2 wt. %, based on a total weight of the first or second electrolyte composition, e.g. for a layer thickness of 3 μm at a 50% relative humidity. For example, the recombination catalyst may be independently present in the first or second electrolyte composition in an amount from 0.08 wt. % to 8 wt. %, based on a total weight of the first or second electrolyte composition, e.g. for a layer thickness of 3 μm at a 50% relative humidity.

A suitable additive for the first or second electrolyte compositions, may be independently selected from those described above. The additive may be independently present in the first or second electrolyte composition in amounts conventionally known in the art.

The liquid carrier in the first or second electrode composition or electrolyte composition may independently comprise water. When the liquid carrier comprises water, the first or second electrode composition or electrolyte composition may be an aqueous first or second electrode composition and aqueous electrolyte composition.

The concentration of water in the liquid carrier may be at least 25% by volume of the liquid carrier. The concentration of water in the liquid carrier may be at least 40% by volume of the liquid carrier. Preferably, the concentration of water in the liquid carrier may be at least 50% by volume of the liquid carrier. More preferably, the concentration of water in the liquid carrier may be at least 60% by volume of the liquid carrier. Still more preferably, the concentration of water in the liquid carrier may be at least 70% by volume of the liquid carrier. Most preferably, the concentration of water in the liquid carrier may be at least 75% by volume of the liquid carrier.

In a further embodiment, the liquid carrier may further comprise one or more C₁-C₄ alcohols. The one or more C₁-C₄ alcohols may preferably comprise one or more C₂-C₄ alcohols, such as one or both of ethanol and propan-1-ol.

The concentration of C₁-C₄ alcohol(s) in the liquid carrier may be less than 75% by volume of the liquid carrier; or less than 60% by volume; or less than 50% by volume; or less than 40% by volume; or less than 30% by volume, based upon the total volume of the liquid carrier.

The liquid carrier preferably comprises water and one or both of ethanol and propan-1-ol.

The concentration of water in the liquid carrier may be in the range of from 25% to 99% by volume of the liquid carrier with the balance being one or more C₁-C₄ alcohols. The concentration of water in the liquid carrier may be in the range of from 40% to 95% by volume of the liquid carrier with the balance being one or more C₁-C₄ alcohols. Preferably, the concentration of water in the liquid carrier may be in the range of from 50% to 90% by volume of the liquid carrier with the balance being one or more C₁-C₄ alcohols. More preferably, the concentration of water in the liquid carrier may be in the range of from 60% to 85% by volume of the liquid carrier with the balance being one or more C₁-C₄ alcohols. Still more preferably, the concentration of water in the liquid carrier may be in the range of from 70% to 85% by volume of the liquid carrier with the balance being one or more C₁-C₄ alcohols. Most preferably, the concentration of water in the liquid carrier may be in the range of from 75% to 85% by volume of the liquid carrier with the balance being one or more C₁-C₄ alcohols.

The liquid carrier may further comprise a glycol ether such as dipropylene glycol (DPG) or propylene glycol methyl ether (PGME).

The first or second electrode composition or electrode composition may independently comprise greater than about 35 wt. %, greater than about 50 wt. %, greater than about 70 wt. %, greater than about 80 wt. %, or greater than about 90 wt. % liquid carrier, based on a total weight of the ionomer and liquid carrier in the composition, such as the first or second electrode composition or electrolyte composition. For example, the liquid carrier may be independently present in the first or second electrode composition or electrolyte composition in an amount from about 35 wt. % to about 99 wt. %, based on a total weight of the ionomer and liquid carrier in the composition.

It will be appreciated that the specific concentrations of the components in the first electrode composition and electrolyte composition that are required to achieve the benefits herein described may vary widely within the ranges listed, depending, for example, on the first porous support or second porous support to which the composition is to be applied, since the wettability of the porous support will vary depending, for example, on porosity, pore diameter, and surface energy of the porous support. The desired catalyst loading in the first or second electrode composition will also impact the desired component concentrations. As a result, the above concentrations are provided as guidelines, understanding that some degree of optimization, well within the purview of those of ordinary skill in the art, may be necessary depending on the chosen porous support and desired catalyst loading.

The first or second electrode compositions or electrolyte composition may independently further comprise a water-insoluble component comprising one or both of a water-insoluble alcohol and a water-insoluble carboxylic acid. In some embodiments, the water-insoluble component comprises a C₅₊ alcohol, a C₅₊ carboxylic acid, or a combination thereof. As used herein, C₅₊ refers to compounds having five or more carbon atoms. Preferably, the water-insoluble component comprises a C₅-C₁₀ alcohol, a C₅-C₁₀ carboxylic acid, or a combination thereof. Thus, in some embodiments, the water-insoluble component comprises a water-insoluble alcohol, such as, for example, 1-pentanol, 1-hexanol, 1-heptanol, 1-octanol, 2-ethyl-1-hexanol, 1-nonanol, 1-decanol, or a combination thereof. In some embodiments, the water-insoluble component comprises a water-insoluble carboxylic acid, such as, for example, n-pentanoic acid, n-hexanoic acid, n-heptanoic acid, n-octanoic acid, n-nonanoic acid, n-decanoic acid or a combination thereof. As used here, the term “a combination thereof” refers to any combination of two or more species in the immediately preceding list. Branched alcohols and/or branched carboxylic acids are also contemplated, as are various combinations of C₅₊ alcohols and C₅₊ carboxylic acids.

The water-insoluble component may be present in the first or second electrode composition or electrolyte composition in an amount less than about 20 wt. %, less than about 15 wt. %, less than about 10 wt. %, less than about 8 wt. %, less than about 6 wt. %, or less than about 4 wt. %, based on a total weight of the ion exchange material and liquid carrier in the composition. For example, the water-insoluble component may be present in the first or any second electrode composition or electrolyte composition in an amount from 0.5 wt. % to 20 wt. %, e.g., from 0.5 wt. % to 15 wt. %, from 0.5 wt. % to 10 wt. %, from 1 wt. % to 20 wt. %, from 5 wt. % to 20 wt. %, or from 10 wt. % to 20 wt. %, based on a total weight of the ion exchange material and liquid carrier in the composition. The weight percentages recited herein should be considered as applying to the collective amount of all water-insoluble components for embodiments employing more than one water-insoluble component.

Such first electrode compositions and electrolyte compositions comprising the above water-insoluble component produce low contact angles when the compositions are applied to a porous support, such as a first porous support or a second porous support. These first electrode composition or electrolyte compositions satisfactorily wet the first porous support or second porous support even with little or no use of water-soluble alcohols and show low reticulation during the drying process. “Low reticulation” as used herein is intended to mean any film that contracts less than 15% in width, less than 15% in length, and for which the final area of the film comprised less than 15% de-wetting defects. Reticulation was assessed by pipetting 60-80 microliters of the electrode layer composition onto the electrolyte layer, then using a pipet bulb to spread the electrode layer composition on the electrolyte layer to form a film with a length of 4-6 cm and a width of 7-15 mm, then drying the film in less than 1 minute with a heat gun while visually inspecting.

Without being limited by theory, it is speculated that the ion exchange material, which is not considered a surfactant, surprisingly emulsifies the water-insoluble component.

The first or second electrode compositions and electrolyte compositions have adequate stability to permit coating by the manufacturing processes described herein. The first or second electrode compositions and electrolyte compositions according to various embodiments may include an emulsion or a suspension such that the compositions may maintain a single phase during the depositing process (i.e., the compositions do not separate into an “oil-rich layer” and “water-rich layer” too rapidly to prevent application to the porous support and heating to remove the liquid carrier). According to various embodiments, the first or second electrode compositions and electrolyte compositions remain homogenous where the components (e.g. oil, water, etc.) are uniformly distributed during at least the step of application to the porous support.

### Test Methods

### Bubble Point of the Porous Support

The Bubble Point was measured according to the procedures of ASTM F316-86 (1986). Isopropyl alcohol was used as the wetting fluid to fill the pores of the test specimen, such as the porous support. The Bubble Point is the pressure of air required to create the first continuous stream of bubbles detectable by their rise through the layer of isopropyl alcohol covering the porous support. This measurement provides an estimation of maximum pore size.

### Non-Contact Thickness

A sample of porous support was placed over a flat smooth metal anvil and tensioned to remove wrinkles. The height of the porous support on the anvil was measured and recorded using a non-contact Keyence LS-7010M digital micrometer. Next, the height of the anvil without the porous support was recorded. The thickness of the porous support was taken as a difference between micrometer readings with and without porous structure being present on the anvil.

### Mass-Per-Area

Each porous support was strained sufficiently to eliminate wrinkles, and then a 10 cm² piece was cut out using a die. The 10 cm² piece was weighed on a conventional laboratory scale. The mass-per-area (M/A) was then calculated as the ratio of the measured mass to the known area. This procedure was repeated 2 times and the average value of the M/A was calculated.

### Apparent Density of Microporous Layer

Apparent density of porous support was calculated using the non-contact thickness and mass-per-area data using the following formula:

$$Apparent {density}_{microporous layer} = \frac{\{ M / {A}_{microporous layer} \}}{\{ non - contact thickness \}} = [ g / cc ]$$

### Equivalent Weight (EW) of an IEM

The following test procedure is appropriate for IEM comprised of a single ionomer resin or a mixture of ionomer resins that is in the proton form (i.e., that contains negligible amounts of other cations), and that is in a solution that contains negligible other ionic species, including protic acids and dissociating salts. If these conditions are not met, then prior to testing, the solution must be purified from ionic impurities according to a suitable procedure as would be known to one of ordinary skill in the art, or the impurities must be characterized and their influence on the result of the EW test must be corrected for.

As used herein, the EW of an IEM refers to the case when the IEM is in its proton form at 0% RH with negligible impurities. The IEM may comprise a single ionomer or a mixture of ionomers in the proton form. An amount of IEM solution with solids concentration determined as described above containing 0.2 grams of solids was poured into a plastic cup. The mass of the ionomer solution was measured via a conventional laboratory scale (obtained from Mettler Toledo, LLC, USA). Then, 5 ml of deionized water and 5 ml of 200 proof denatured ethanol (SDA 3C, Sigma Aldrich, USA) is added to the ionomer solution in the cup. Then, 55 ml of 2N sodium chloride solution in water was added to the IEM solution. The sample was then allowed to equilibrate under constant stirring for 15 minutes. After the equilibration step, the sample was titrated with 1N sodium hydroxide solution. The volume of 1N sodium hydroxide solution that was needed to neutralize the sample solution to a pH value of 7 was recorded. The EW of the IEM (EWIEM) was calculated as:

$${EW}_{IEM} = \frac{\{ \begin{matrix}Mass of \\ IEM solution\end{matrix} \} \times \{ \begin{matrix}wt \% solids of \\ IEM solution\end{matrix} \}}{\{ \begin{matrix}Volume of \\ NaOH solution\end{matrix} \} \times \{ \begin{matrix}Normality of \\ NaOH solution\end{matrix} \}} = [ \frac{g}{mole eq .} ]$$

When multiple IEMs were combined to make a composite membrane, the average EW of the IEMs in the composite membrane was calculated using the following formula:

$${EW}_{IEM \_ average} = {[ \frac{\{ \begin{matrix}Mass fraction \\ of IEM 1\end{matrix} \}}{\{ {EW}_{IEM , 1} \}} + \frac{\{ \begin{matrix}Mass fraction \\ of IEM 2\end{matrix} \}}{\{ {EW}_{IEM , 2} \}} + … \cdot \frac{\{ \begin{matrix}Mass fraction \\ of IEM N\end{matrix} \}}{\{ {EW}_{IEM , N} \}} ]}^{- 1} = [ \text{} \frac{g}{mole eq .} ] ,$$

where the mass fraction of each IEM is with respect to the total amount of all IEMs. This formula was used both for composite membranes containing ionomer blends and for composite membranes containing ionomer layers.

### Crack Properties Measurement

A sample of an electrode layer is scanned under a laser scanning microscope such as of the model OLS5100 provided by company OLYMPUS, Japan, to measure the height distribution of the electrode layer. The scan area is about 630×630 μm and 6 areas were scanned with a resolution of 0.7 μm/pixel.

The crack area is defined from the height distribution histogram by selecting the appropriate height data. The Crack total area in % is defined as the crack area identified from the scan area divided by the total scan area.

The Crack width size data are determined using a common image analysis algorithm called “Skeletonize” to identify the center line of the crack. The distance closest between each point that makes up the centerline and the edge of the crack are measured. This operation was done using “Distance map” function built into ImageJ software provided by National Institutes of Health (USA). The data for each crack is then listed and the average, median and maximum crack width sizes in μm over the full scan area are calculated.

### EXAMPLES

The present disclosure will be better understood in view of the following non-limiting examples. All ion exchange materials prior to manufacturing of composite membranes were in the form of solutions based on water and ethanol mixtures as solvent with water content in solvent phase being less than 50%.

### Example 1

An ePTFE membrane as first porous support with a mass per area of 4.1 g/m², a thickness of 12 μm, an apparent density of 0.4 g/cc and a bubble point of 380 kPa was hand strained to eliminate wrinkles and restrained in this state by a metal frame. Next, a first laydown of perfluorosulfonic acid (PSFA) solution (first electrolyte composition comprising first ion exchange material, IEM solution) with an EW of about 720 g/eq (IW101-700 obtained from AGC Inc, Japan) with a solution composition of 39.1% water, 45.9% ethanol, 18.0% solids, was coated onto the top side of a polymer sheet substrate. The polymer sheet substrate (obtained from DAICEL VALUE COATING LTD., Japan) is a releasable backer layer and comprises PET and a protective layer of cyclic olefin copolymer (COC) and was oriented with the COC side on top. The IEM (PFSA solution) coating was accomplished using a Meyer bar with nominal wet coating thickness of 100 μm. While the coating was still wet, the ePTFE membrane previously restrained in metal frame was laminated to the IEM coating, whereupon the IEM solution imbibed into the pores of the first porous support. The resulting intermediate composite material was subsequently dried in a convection oven with air inside at a temperature of about 160° C. Upon drying, the first porous support (ePTFE membrane) became fully imbibed with the first IEM. The first IEM also formed a layer between the bottom surface of the first porous support and the polymer sheet substrate (releasable backer layer).

A second ePTFE membrane as second porous support with mass per area of 0.7 g/m², a thickness of 6.6 μm, an apparent density of 0.1 g/cc and a bubble point of 0.7 kPa was hand strained to eliminate wrinkles and restrained in this state by a metal frame. A second laydown of PSFA solution (second electrolyte composition comprising first ion exchange material) with an EW of about 720 g/eq (IW101-700 obtained from AGC Inc, Japan), and a solution composition of 43.6% water. 55.4% ethanol, 1.0% solids, was coated onto the top surface of the intermediate composite material (the surface opposite the polymer sheet substrate) using a drawdown bar with nominal wet coating thickness of 100 μm. While the coating was still wet, the second ePTFE membrane (second porous support) previously restrained in metal frame was applied to the second coating, whereupon the IEM solution (second electrolyte composition) in general does not imbibe the second ePTFE membrane in a significant amount. The IEM solution may imbibe into a bottom area of the second ePTFE membrane, but the main region of the second porous structure remains un-imbibed. This final composite material was subsequently dried in a convection oven with air inside at a temperature of about 160° C. forming a composite electrolyte membrane. The composite electrolyte membrane was fully occlusive of first ePTFE layer with IEM (reinforced electrolyte layer), and maintained the open structure of the second ePTFE layer. One unreinforced layer of IEM is present between the releasable backer layer and the first ePTFE layer and another unreinforced layer of IEM is present between the first ePTFE layer and the second ePTFE layer. The composite electrolyte membrane (PEM) has a thickness of about 20 μm, an EW of about 1000 g/mol and a mass per area of about 24.5 g/m². The composite electrolyte membrane has a similar structure to the embodiment of FIG. 14A.

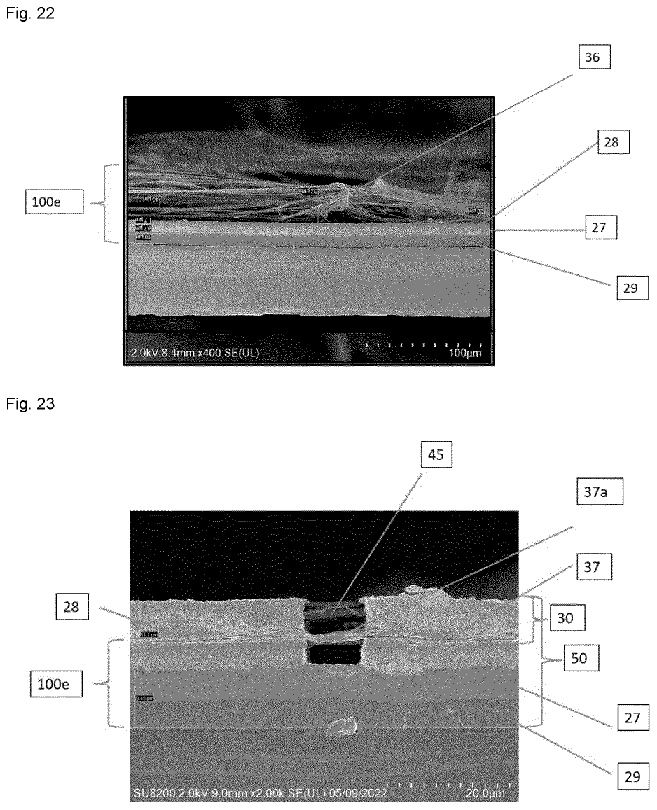

FIG. 22 is a scanning electron micrograph of the composite electrolyte membrane of example 1. The first unreinforced electrolyte layer 29, the reinforced electrolyte layer 27 and the second unreinforced electrolyte layer 28 have together a thickness of about 20 μm. The second porous support 36 has a thickness from about 20 to about 43 μm.

For the cathode electrode layer, a first electrode composition solution was prepared comprising of 2.7 vol % second ion exchange material PSFA solution with EW of about 900 g/eq (obtained from AGC Inc, Japan), 2.1 vol % Pt supported on carbon catalyst (TEC10F50E-HT obtained from Tanaka Kikinzoku Kogyo K.K., Japan; first catalyst) resulting in a total solid content of 4.8 Vol %, mixed and dispersed in a solution of about 76.2 vol % N-Propanol (NPA) and 19 vol % distilled water. The first electrode (cathode) composition solution was applied to the composite electrolyte membrane by a direct coating method. A single layer slot die was used with a shim of 125 μm and a coating width of 54 mm. The slot die was in liquid connection with a pump having a pump flowrate of 1.94 ml/min. The first electrode composition solution was coated on the porous un-imbibed structure of the second ePTFE membrane (second porous support) of the multilayer composite electrolyte membrane, wherein the first electrode composition solution is substantially fully impregnating the un-imbibed porous structure of the second ePTFE membrane up to the second laydown of first IEM (second electrolyte composition). The coating wet thickness of the first electrode composition solution was 72 μm and the coating speed 0.5 m/min. Therefore, the porous structure of the second support of the composite electrolyte membrane is fully imbibed with the first electrode composition solution. Excess first electrode composition forms a layer of first electrode composition on top of the second porous support. The first electrode composition solution was then dried at 60° C. for at least 4 mins. This produced a first electrode (cathode) with a thickness of about 11 μm and a Pt loading of about 0.41 mg/cm². The first electrode comprises a reinforced electrode layer of second porous support fully imbibed with first catalyst and second IEM and an unreinforced first electrode layer comprising first catalyst and second IEM.

FIG. 23 is a scanning electron micrograph of the cathode coated composite electrolyte membrane 200. This is illustrative of the embodiment shown in FIG. 6A without the second electrode layer 130. FIG. 23 shows the presence of a crack 60 in the cathode layer 30. The crack 60 penetrates below the reinforced electrode layer 37. However, it is apparent that reinforced electrode layer 37a in the volume of the crack, comprising the second ePTFE membrane porous support imbibed with cathode catalyst and ion exchange material, is not disrupted by the crack 60.

For the anode electrode layer, a second electrode composition solution was prepared comprising 3.16 vol % third ion exchange material PSFA solution with an EW of about 900 g/eq (obtained from AGC Inc, Japan), 2.83 vol % Pt supported on carbon catalyst (TEC10EA50E obtained from Tanaka Kikinzoku Kogyo K.K., Japan; third catalyst) resulting in a total solid content of 4.8 Vol %, mixed and dispersed in solution of about 37.6 vol % NPA and 56.4 vol % distilled water. The second electrode (anode) composition solution was applied to the composite electrolyte membrane by a direct coating method. A single layer slot die was used with a shim of 125 μm and a coating width of 54 mm. The slot die was in liquid connection with a pump having a pump flowrate of 0.65 ml/min. The polymer sheet substrate (releasable backer layer) was removed from the composite electrolyte membrane. The second electrode (anode) composition solution was coated on the exposed composite electrolyte membrane surface. The coating wet thickness was 15 μm and the coating speed 0.8 m/min. The second electrode (anode) composition solution was then dried at 60° C. for at least 4 mins. This produced a second electrode (anode) layer with Pt loading of about 0.11 mg/cm².

The membrane electrode assembly has a similar structure to the embodiment of FIG. 6A.

### Example 2

An ePTFE membrane as first porous support with a mass per area of 4.1 g/m², a thickness of 12 μm, an apparent density of 0.4 g/cc and a bubble point of 380 kPa was hand strained to eliminate wrinkles and restrained in this state by a metal frame. Next, a first laydown of PSFA solution (first electrolyte composition comprising first IEM) with an EW of about 700 g/eq (IW101-700 obtained from AGC Inc, Japan), with a solution composition of 39.1% water. 45.9% ethanol, 18.0% solids, was coated onto the top side of a polymer sheet substrate. The polymer sheet substrate (obtained from DAICEL VALUE COATING LTD., Japan) is a releasable backer layer and comprises PET and a protective layer of cyclic olefin copolymer (COC) and was oriented with the COC side on top. The IEM (PFSA solution; first electrolyte composition) coating was accomplished using a Meyer bar with nominal wet coating thickness of 100 μm. While the coating was still wet, the ePTFE membrane previously restrained in metal frame was laminated to the coating, whereupon the IEM solution (first electrolyte composition) imbibed into the pores of the first porous support. The resulting intermediate composite material was subsequently dried in a convection oven with air inside at a temperature of about 160° C. Upon drying, the first porous support (ePTFE membrane) became fully imbibed with the first IEM. The first IEM also formed a layer between the bottom surface of the first porous support and the polymer sheet substrate.

An ePTFE membrane as second porous support with a mass per area of 0.87 g/m², a thickness of 2.5 μm, an apparent density of 0.035 g/cc and a bubble point of 19 kPa was hand strained to eliminate wrinkles and restrained in this state by a metal frame. A second laydown of PSFA solution (second electrolyte composition comprising first IEM) with an EW of about 700 g/eq (IW101-700 obtained from AGC Inc, Japan), and a solution composition of 43.6 wt. % water, 55.4 wt. % ethanol, 1.0 wt. % solids, was coated onto the top surface of the intermediate composite material (the surface opposite the polymer sheet substrate) using a drawdown bar with nominal wet coating thickness of 100 μm. While the coating was still wet, the second ePTFE membrane previously restrained in metal frame was laminated to the coating, whereupon the second electrolyte composition partially imbibed into the pores of the second ePTFE membrane. This final composite material was subsequently dried in a convection oven with air inside at a temperature of about 160° C. The multilayer composite membrane comprises a fully occlusive first ePTFE layer, while the second ePTFE layer is partially imbibed with the first IEM. The second ePTFE layer has an occlusive portion imbibed with IEM and an unimbibed region with an open porous structure. A layer of first IEM is located between the releasable backer layer and the first ePTFE layer. The composite electrolyte membrane (PEM) has a thickness of about 13.5 μm, an EW of about 988 g/mol and a mass per area of about 23 g/m². The composite electrolyte membrane has a similar structure to the embodiment of FIG. 16A, without the presence of the recombination catalyst.

For the cathode electrode layer, a first electrode composition solution was prepared comprising a 2.7 vol % second ion exchange material PSFA solution with an EW of about 900 g/eq (obtained from AGC Inc, Japan), and a 2.1 vol % Pt supported on carbon catalyst (TEC10F50E-HT obtained from Tanaka Kikinzoku Kogyo K.K., Japan; first catalyst) resulting in a total solid content of 4.8 vol %, mixed and dispersed in solution of about 76.2 vol % NPA and 19 vol % distilled water. The first electrode composition solution was applied to the composite electrolyte membrane (PEM) by a direct coating method. A single layer slot die was used with a shim of 150 μm and a coating width of 54 mm. The slot die was in liquid connection with a pump having a pump flowrate of 2.38 ml/min. The first electrode composition solution was coated on the porous un-imbibed porous structure of the second ePTFE membrane (second porous support) of the multilayer composite electrolyte membrane wherein the first electrode composition solution substantially fully impregnates the remaining open porous structure of the second ePTFE membrane up to the second laydown of first IEM of the electrolyte. The coating wet thickness of the first electrode composition solution was 88 μm and the coating speed 0.5 m/min. The second porous support of the composite electrolyte membrane is fully imbibed, partially with the second application of the first IEM and partially with the first electrode composition solution, one on top of the other. Excess first electrode composition forms a layer of first electrode composition on top of the second porous support. The first electrode composition solution was then dried at 60° C. for at least 4 mins. This produced a first (cathode) electrode layer with a thickness of about 11 μm and a Pt loading of about 0.39 mg/cm². The first electrode comprises a reinforced electrode layer of with a region of second porous support fully imbibed with first catalyst and second IEM and an unreinforced first electrode layer comprising first catalyst and second IEM.

For the anode electrode layer, a second electrode composition solution was prepared comprising 3.16 vol % third ion exchange material PSFA solution with an EW of about 900 g/eq (obtained from AGC Inc, Japan), 2.83 vol % Pt supported on carbon catalyst (TEC10EA50E obtained from Tanaka Kikinzoku Kogyo K.K., Japan; third catalyst) resulting in a total solid content of 4.8 vol %, mixed and dispersed in solution of about 37.6 vol % NPA and 56.4 vol % distilled water. The second electrode composition solution was applied to the composite electrolyte membrane (PEM) by a direct coating method. A single layer slot die was used with a shim of 125 μm and a coating width of 54 mm. The slot die was in liquid connection with a pump having a pump flowrate of 0.65 ml/min. The polymer sheet substrate (releasable backer layer) was removed from the composite electrolyte membrane. The second electrode composition solution was coated on the exposed composite electrolyte membrane surface. The coating wet thickness was 15 μm and the coating speed 0.8 m/min. The second electrode composition solution was then dried at 60° C. for at least 4 mins. This produced a second electrode (anode) layer with a Pt loading of about 0.11 mg/cm².

The membrane electrode assembly has a similar structure to the embodiment of FIG. 7 without the presence of recombination catalyst 19.

### Comparative Example 1

A commercially available composite electrolyte membrane (from W. L. Gore & Associates) with a thickness of 15 μm having a releasable backer layer is provided. The composite electrolyte membrane comprises one ePTFE membrane as porous support fully impregnated with ion exchange material comprising PFSA with an EW of about 720 g/eq (obtained from AGC Inc, Japan) and covered with a layer of ion exchange material on both sides of the ePTFE membrane.

For the cathode layer, a first electrode composition solution was prepared consisting of 2.7 vol % second ion exchange material PSFA solution with an EW of about 900 g/eq(obtained from AGC Inc, Japan), 2.1 vol % Pt supported on carbon catalyst (TEC10F50E-HT obtained from Tanaka Kikinzoku Kogyo K.K., Japan; first catalyst) resulting in a total solid content of 4.8 Vol %, mixed and dispersed in solution of about 76.2 vol % NPA and 19 vol % distilled water. The first electrode composition solution was applied to the composite electrolyte membrane (PEM) by a direct coating method. A single layer slot die was used with a shim of 150 μm and a coating width of 54 mm. The slot die was in liquid connection with a pump having a pump flowrate of 4.37 ml/min. The coating wet thickness was 81 μm and the coating speed 0.5 m/min. The first electrode composition solution was then dried at 60° C. for at least 4 mins. This produced a first electrode (cathode) layer with a Pt loading of about 0.41 mg/cm². The first electrode layer comprises first catalyst and second IEM and is without a porous support.

For the anode electrode layer, a second electrode composition solution was prepared comprising 3.16 vol % third ion exchange material PSFA solution with an EW of about 900 g/eq (obtained from AGC Inc, Japan), 2.83 vol % Pt supported on carbon catalyst (TEC10EA50E obtained from Tanaka Kikinzoku Kogyo K.K., Japan; second catalyst) resulting in a total solid content of 4.8 Vol %, mixed and dispersed in solution of about 37.6 vol % NPA and 56.4 vol % distilled water. The second electrode (anode) composition solution was applied to the composite electrolyte membrane (PEM) by a direct coating method. A single layer slot die was used with a shim of 125 μm and a coating width of 54 mm. The slot die was in liquid connection with a pump having a pump flowrate of 0.65 ml/min. The polymer sheet substrate (releasable backer layer) was removed from the composite electrolyte membrane. The second electrode (anode) composition solution was coated on the exposed composite electrolyte membrane surface. The coating wet thickness was 15 μm and the coating speed 0.8 m/min. The second electrode (anode) composition solution was then dried at 60° C. for at least 4 mins. This produced a second electrode (anode) layer with a Pt loading of about 0.11 mg/cm². The second electrode layer comprises second catalyst and third IEM and is without a porous support.

TABLE 1
Cathode (first electrode) layer properties

| | Cathode (first electrode) layer properties | | | | |
|---|---|---|---|---|---|
| | | | | Crack | Crack |
| | | Cathode | | Max | Median |
| | Pt | layer | Crack | width | width |
| | loading | thickness | total | size | size |
| Sample | (mg/cm²) | (μm) | area (%) | (μm) | (μm) |
| Example 1 | 0.41 | 11 | 16.3 | 39 | 3.3 |
| Example 2 | 0.39 | 14 | 14.3 | 13.8 | 5.4 |
| Comparative | 0.41 | 14.5 | 22.4 | 55 | 8.2 |
| Example 1 | | | | | |

### Example 3

An ePTFE membrane as first porous support with a mass per area of 4.1 g/m², a thickness of 12 μm, an apparent density of 0.4 g/cc and a bubble point of 380 kPa was hand strained to eliminate wrinkles and restrained in this state by a metal frame. Next, a first laydown of PSFA solution (first electrolyte composition comprising first IEM) with an EW of about 700 g/eq (IW101-700 obtained from AGC Inc, Japan), with a solution composition of 39.1% water. 45.9% ethanol, 18.0% solids, was coated onto the top side of a polymer sheet substrate. The polymer sheet substrate (obtained from DAICEL VALUE COATING LTD., Japan) is a releasable backer layer and comprises PET and a protective layer of cyclic olefin copolymer (COC) and was oriented with the COC side on top. The first IEM (PFSA solution; first electrolyte composition) coating was accomplished using a Meyer bar with nominal wet coating thickness of 100 μm. While the coating was still wet, the ePTFE membrane previously restrained in metal frame was laminated to the coating, whereupon the first IEM solution (first electrolyte composition) imbibed into the pores of the first porous support. The resulting intermediate composite material was subsequently dried in a convection oven with air inside at a temperature of about 160° C. Upon drying, the first porous support (ePTFE membrane) became fully imbibed with the first IEM. The first IEM also formed a layer between the bottom surface of the first porous support and the polymer sheet substrate.

An ePTFE membrane as second porous support with a mass per area of 0.87 g/m², a thickness of 2.5 μm, an apparent density of 0.035 g/cc and a bubble point of 19 kPa was hand strained to eliminate wrinkles and restrained in this state by a metal frame. A second laydown of PSFA solution (second electrolyte composition comprising first IEM and a platinum recombination catalyst) with an EW of about 700 g/eq (IW101-700 obtained from AGC Inc, Japan), comprising 9 wt. % first ion exchange material and 0.74 wt. % recombination catalyst (platinum supported on carbon from N. E. Chemcat Corporation (SA50BK)) and 90.26 wt. % solution of about 43.6 vol. % water, 55.4 vol. % ethanol, was coated onto the top surface of the intermediate composite material (the surface opposite the polymer sheet substrate) using a drawdown bar with nominal wet coating thickness of 100 μm. While the coating was still wet, the second ePTFE membrane previously restrained in metal frame was laminated to the coating, whereupon the second electrolyte composition partially imbibed into the pores of the second ePTFE membrane. This final composite material was subsequently dried in a convection oven with air inside at a temperature of about 160° C. The multilayer composite membrane comprises a fully occlusive first ePTFE layer, while the second ePTFE layer is partially imbibed with the first IEM and the recombination catalyst. The second ePTFE layer has an occlusive portion imbibed with IEM and recombination catalyst and an unimbibed region with an open porous structure. A layer of first IEM is located between the releasable backer layer and the first ePTFE layer. The composite electrolyte membrane has a thickness of about 16.2 μm, an EW of about 940 g/mol and a mass per area of about 22.8 g/m². The composite electrolyte membrane has a similar structure to the embodiment of FIG. 16B.

While the invention has been described in detail, modifications within the spirit and scope of the invention will be readily apparent to the skilled artisan. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by the skilled artisan. Furthermore, the skilled artisan will appreciate that the foregoing description is by way of example only, and is not intended to limit the invention.

1.-32. (canceled)

33. A composite electrolyte membrane, comprising:
a) at least one first porous support including a first porous support; and
b) a second porous support; and
c) a first ion exchange material at least partially embedded within the first porous support to provide a reinforced electrolyte layer and to render at least a part of the first porous support occlusive; wherein
d) the second porous support comprises an un-imbibed region which is substantially free of the first ion exchange material.

34. The composite electrolyte membrane according to claim 33, wherein the first porous support and the second porous support are the same porous support or are different porous supports.

35.-36. (canceled)

37. The composite electrolyte membrane according to claim 33, wherein the first porous support has a first bubble point and the second porous support has a second bubble point, wherein the second bubble point of the second porous support is less than the first bubble point of the first porous support.

38. The composite electrolyte membrane according to claim 37, wherein the first bubble point of the first porous support is 100 kPa or more, is 200 KPa or more, is 300 kPa or more, is 400 kPa or more, or is 500 kPa or more; and/or wherein the second bubble point of the second porous support is less than 100 kPa, is 50 kPa or less, is 25 kPa or less, or is 5 kPa or less.

39.-41. (canceled)

42. The composite electrolyte membrane according to claim 33, wherein the first porous support has a mass per area of less than 10 g/m², less than 5 g/m² or less than 2.5 g/m²; and/or wherein second porous support has a mass per area of less than 3 g/m² or less than 1.5 g/m².

43. (canceled)

44. The composite electrolyte membrane according to claim 33, wherein the first porous support and the second porous support are in direct contact or are not in direct contact.

45. The composite electrolyte membrane according to claim 33, wherein the first porous support and the second porous support are unitary.

46. The composite electrolyte membrane according to claim 33, comprising at least one layer of the first ion exchange material, or at least one layer of the first ion exchange material and a recombination catalyst, between the first porous support and the second porous support.

47. The composite electrolyte membrane according to claim 33, wherein the second porous support is partially imbibed with the first ion exchange material, or wherein the second porous support is partially imbibed with the first ion exchange material and a recombination catalyst.

48. (canceled)

49. The composite electrolyte membrane according to claim 33, wherein the reinforced electrolyte layer has a first surface and an opposing second surface, and wherein the first ion exchange material forms a layer on one or both of the first surface and the second surface.

50. (canceled)

51. The composite electrolyte membrane according to claim 47, wherein the second porous support is about less than 20%, or less than 10% or less than 5% occluded with the first ion exchange material.

52. (canceled)

53. The composite electrolyte membrane according to claim 33, wherein the first porous support and the second porous support independently comprise a fluorinated polymer or a hydrocarbon polymer.

54. The composite electrolyte membrane according to claim 53, wherein fluorinated polymer is polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) or mixtures thereof.

55. The composite electrolyte membrane according to claim 53, wherein the hydrocarbon polymer comprises polyethylene, polypropylene, polycarbonate, polystyrene, or mixtures thereof.

56. The composite electrolyte membrane according to claim 33, wherein the ion exchange material comprises at least one ionomer, optionally wherein the at least one ionomer comprises a proton conducting polymer, further optionally wherein the proton conducting polymer comprises hydrocarbon ionomer, or perfluorinated ionomer, or perfluorosulfonic acid.

57.-59. (canceled)

60. A method for the manufacture of a composite electrolyte membrane, said method comprising at least the steps of:
providing a releasable backing layer
applying a first electrolyte composition comprising first ion exchange material and liquid carrier as a layer of controlled thickness to the releasable backing layer in a single or multiple pass coating technique;
laminating a first porous support over at least a portion of the layer of the first electrolyte composition to at least partially imbibe the first porous support with first electrolyte composition to provide a first electrolyte composition imbibed first porous support;
heating the first electrolyte composition imbibed first porous support to remove liquid carrier to provide a reinforced electrolyte layer;
laminating a second electrolyte composition comprising first ion exchange material and liquid carrier over the reinforced electrolyte layer as a layer of controlled thickness in a single or multiple pass coating technique;
applying a second porous support over at least a portion of the layer of second electrolyte composition;
heating the second electrolyte composition to remove liquid carrier.

61. The method according to claim 60 wherein the second electrolyte composition further comprises a recombination catalyst.

62. A membrane electrode assembly for an electrochemical device, said membrane electrode assembly comprising;
a) at least one first porous support including a first porous support; and
b) a second porous support; and
c) a first ion exchange material at least partially embedded within the first porous support to provide a reinforced electrolyte layer and to render at least a part of the first porous support occlusive; wherein
d) the second porous support comprises a region which is substantially free of the first ion exchange material and the said region being at least partially imbibed with a second ion exchange material and a first catalyst to form a first electrode.

63. The membrane electrode assembly of claim 62, wherein the first porous support has a first bubble point, and the second porous support has a second bubble point, wherein the second bubble point of the second porous support is less than the first bubble point of the first porous support.

64. The membrane electrode assembly of claim 63, wherein the first bubble point of the first porous support is 100 kPa or more, is 200 KPa or more, is 300 kPa or more, is 400 kPa or more, or is 500 kPa or more; and/or wherein the second bubble point of the second porous support is less than 100 kPa, is 50 kPa or less, is 25 kPa or less, or is 5 kPa or less.
